(19) United States
(12) Patent Application Publication
(10) Pub. No.: US 2026/0162970 A1
(43) Pub. Date: Jun. 11, 2026

(54) SOLID-STATE BATTERIES WITH SILICON ANODE AND SULFIDE ION CONDUCTOR

(71) Applicant: Northeastern University, Boston, MA (US)

(72) Inventors: Daxian Cao, Malden, MA (US); Hongli Zhu, Newton, MA (US)

(21) Appl. No.: 18/707,498

(22) PCT Filed: Nov. 4, 2022
(86) PCT No.: PCT/US2022/048976

§ 371 Date: May 3, 2024

Related U.S. Application Data
(60) Provisional application No. 63/275,940, filed on Nov. 4, 2021.
(60) Provisional application No. 63/363,187, filed on Apr. 19, 2022.

(51) Int. Cl. H01M 4/36; H01M 4/02; H01M 4/38; H01M 4/525; H01M 4/62; H01M 10/052; H01M 10/0562

(52) U.S. Cl. CPC H01M 4/366; H01M 4/386; H01M 4/525; H01M 4/62; H01M 4/625; H01M 10/052; H01M 10/0562; H01M 2004/021; H01M 2300/008

(57) ABSTRACT

All-solid-state batteries based on silicon anodes and sulfide ion conductors are disclosed. The silicon anode includes silicon particles that are coated with Li₆PS₅Cl and mixed with carbon black. The silicon anode is made by mixing silicon particles with Li₂S and P₂S₅ in a solvent, removing the solvent, annealing the silicon particles coated with Li₆PS₅Cl, and ball milling the silicon particles coated with Li₆PS₅Cl with Li₆PS₅Cl and carbon black. Also disclosed herein is a battery comprising an anode made of silicon particles coated with Li₆PS₅Cl and mixed with carbon black, a cathode that includes a metal coated with Li₂SiOₓ wherein X is from 2.9 to 3.0, and a solid electrolyte membrane separating the anode and the cathode. Methods of making the battery and the cathode are also disclosed herein.

### RELATED APPLICATIONS

This application claims the benefit of U.S. Provisional Application No. 63/275,940, filed on Nov. 4, 2021. This application also claims the benefit of U.S. Provisional Application No. 63/363,187, filed on Apr. 19, 2022. The entire teachings of the above applications are incorporated herein by reference.

### GOVERNMENT SUPPORT

This invention was made with government support under Grant No. 1924534 from the National Science Foundation. The government has certain rights in the invention.

### BACKGROUND

Great efforts have been made to develop all-solid-state lithium batteries (ASLBs) because of their attractive inflammability and prospective high energy densities.^{[1]} Among various superionic conductors, sulfide solid-state electrolytes (SEs) exhibit exceedingly high room-temperature ionic conductivities (>1 mS cm⁻¹), which enables ASLBs to work without extra heating.^{[2]} However, sulfide SEs suffer from a narrow electrochemical stability window (1.7˜2.3 V, vs. Li⁺/Li) and high reactivity towards many conventional electrodes, such as transition metal oxide cathodes and Li metal anode.^{[3]} To achieve comparable or even higher energy densities than the commercial lithium-ion batteries, electrodes that exhibit high energy density and compatibility with sulfide SEs are needed.^{[4]}

### SUMMARY

With the frequently reported thermal runaway of Lithium-ion batteries (LiBs), all-solid-state lithium (Li) batteries (ASLBs), which use inflammable solid electrolytes (SEs), are considered able to address the safety issue effectively. Currently, Li metal anodes have gathered enormous attention but still face many challenges for large-scale manufacturing and industrial applications. Silicon (Si) is also a high-capacity anode, but using Si in ASLBs lacks sufficient attention. Described herein, a high voltage single crystal LiNi_{0.8}Mn_{0.1}Co_{0.1}O₂ was stabilized with Li silicate, and further coupled with Si anode through sulfide solid electrolyte Li₆PS₅Cl for ASLBs. From the perspectives of cost, energy densities, interface compatibility, and processability in manufacturing and practical applications, Si with Li metal anodes have been systematically compared in sulfide based ASLBs. The electrochemical behavior of Si anodes have been evaluated and its stability during cycling has been investigated through impedance studies and surface characterizations. The ASLBs stacking the interface-protected cathode, Li₆PS₅Cl, and Si anode delivered an ultrahigh energy density of 285 Wh kg⁻¹ at cell-level.

As a typical alloy-type anode, Si possesses an ultrahigh room-temperature theoretical capacity of 3590 mAh g⁻¹, about ten times higher than the conventional graphite.^{[13]} The reduction potential was ˜0.4 V (vs. Li⁺/Li) on average, which avoids the risk of Li dendrite formation.^{[13]} Moreover, Si is one of the most abundant elements on Earth and very affordable. Si anodes thus attract tremendous interest from industries.^{[14]} However, the commercialization of Si anode is challenged by its colossal volume change (˜300%) during cycling and low electrical conductivity.^{[14]} The significant volume expansion and compression create enormous mechanical stress, which causes breaking and pulverization of the electrodes. As a result, the battery capacity decays rapidly. Many strategies, such as designing nanostructures, introducing electrolyte additives, optimizing binders, and compositing with other materials, have been proposed to solve the challenges in liquid electrolytes for commercializing Si anodes.^{[8]} However, the application of Si anode in sulfide SE-based ASLBs lacks investigation. Lee et al. reported sulfide SE-based ASLBs using Si composite anodes with Si particle size ranging from nano-to micro-scales and investigated the effect of carbon additives and external pressure.^{[15-17]} Takada et al. fabricated thin Si films through thin-film fabrication approaches and applied them in ASLBs.^{[18,19]} Though excellent rate performance was achieved in these works, the mass loading of active material was low (<0.23 mg cm⁻²), limiting the energy densities of ASLBs. In addition, the reported ASLBs exhibited short cycling life (<100 cycles) and limited cell-level energy densities (<225 Wh kg⁻¹, excluding the fraction of current collectors and packages).

Disclosed herein are the merits and demerits of using Si anode in ASLBs, which have been evaluated and compared with Li metal. Si anodes show tremendous advances in low cost, excellent compatibility, and high processibility, while the energy density is comparable with Li metal. Si anodes show great potential in practical applications in ASLBs over Li metal at the current stage.

A Si composite anode has been fabricated that shows a high initial capacity of 2737 mAh g⁻¹ (corresponding to 2.64 mAh cm⁻²) with a high initial coulombic efficiency of 85.6% in a half cell. The impedance revolution of Si composite anodes and Li metal anodes during cycling was operando investigated through electrochemical impedance spectroscopy (EIS). The Si composite anode exhibits much better stability than Li metal, and ex situ scanning electron microscopy (SEM) and X-ray photoelectron spectroscopy (XPS) confirmed the excellent stability of the Si composite anode.

A facile method was developed to fabricate a Li₂SiOₓ coating layer on a single-crystal Li₂Ni_{0.8}Mn_{0.1}Co_{0.1}O₂ (Li₂SiOₓ@S-NMC). It delivered high charge and discharge capacities of 224 and 188 mAh g⁻¹ with a high initial coulombic efficiency of 83.9%. The full cell employed the Si composite anode, Li₂SiOₓ@S-NMC cathode, and a thin SE membrane delivered excellent performance. Remarkably, the full cell with 20 mg cm⁻² cathode mass loading delivered the highest energy density of 285 Wh kg⁻¹. Even at the high current density of 3.16 mA cm⁻², the energy density was still as high as 177 Wh kg⁻¹ beyond the average energy density of conventional Li-ion batteries. The full cell showed stable cycling for 800 cycles at C/3 (corresponding to 1.05 mA cm⁻²).

The high compatibility between Si anodes and sulfide solid state electrolytes enables a great performance. These materials are scalable, suitable for large scale manufacturing, have low associated costs, are safe and reliable, and provide high performance results. They can also be used in electric vehicles, portable electronics, and aerospace products.

Described herein is a method of making an anode material. The method can involve milling silicon particles, Li₆PS₅Cl and carbon black to form an anode material, which can be used as an electrode. The silicon particles, the Li₆PS₅Cl, and the carbon black can be milled in a weight ratio of about 60:30:10. The silicon particles can be coated with Li₇P₃S₁₁. Coating the silicon with Li₇P₃S₁₁ can involve mixing the silicon particles with Li₂S and P₂S₅ in a solvent; removing the solvent; and annealing the silicon particles to form silicon particles coated with Li₇P₃S₁₁. The silicon particles coated with Li₇P₃S₁₁, the Li₆PS₅Cl, and the carbon black can be milled in a weight ratio of about 70:20:10. The silicon particles can be powdered silicon particles. The powdered silicon particles can be silicon nanoparticles, for example, silicon nanoparticles having a particle size from about 50 nm to about 100 nm. The milling can be by ball milling.

Described herein is a method of making a cathode. The method can involve coating a metal that includes nickel, manganese, and cobalt; and milling the coated metal that includes nickel, manganese, and cobalt with Li₆PS₅Cl and carbon fibers to form a cathode material, which can be used as an electrode. Coating the metal can include reacting lithium with ethanol to form lithium ethoxide dissolved in the ethanol; adding tetraethyl orthosilicate to the lithium ethoxide dissolved in the ethanol; adding the metal that includes nickel, manganese, and cobalt to the ethanol; and removing the ethanol, thereby forming the coated metal that includes nickel, manganese, and cobalt. The method can include sonicating the ethanol to reduce aggregation of the metal that includes nickel, manganese, and cobalt.

Coating the metal can be performed in an inert atmosphere. The carbon fibers can be vapor-grown carbon fibers. The metal that includes nickel, manganese, and cobalt can be LiNi_{0.8}Mn_{0.1}Co_{0.1}O₂, LiNi_{1/3}Mn_{1/3}Co_{1/3}O₂, LiNi_{0.6}Mn_{0.2}Co_{0.2}O₂, or LiNi_{0.5}Mn_{0.3}Co_{0.2}O₂. The metal that includes nickel, manganese, and cobalt can be a single crystal.

Described herein is a battery. The battery can include an anode that includes silicon particles, Li₆PS₅Cl, and carbon black; a cathode that includes nickel, manganese, and cobalt, wherein the metal is coated with Li₂SiOₓ, wherein X is from 2.9 to 3.0; and a solid electrolyte membrane separating the anode and the cathode. The metal that includes nickel, manganese, and cobalt can be LiNi_{0.8}Mn_{0.1}Co_{0.1}O₂, LiNi_{1/3}Mn_{1/3}Co_{1/3}O₂, LiNi_{0.6}Mn_{0.2}Co_{0.2}O₂, or LiNi_{0.5}Mn_{0.3}Co_{0.2}O₂. The metal that includes nickel, manganese, and cobalt can be a single crystal. The silicon particles can be coated with Li₆PS₅Cl.

Described herein is a method of making a battery. The method can include making an anode, placing a solid electrolyte membrane on a die, placing the anode on one side of the solid electrolyte, and placing a cathode on the other side of the solid electrolyte. The cathode can include a metal that includes nickel, manganese, and cobalt, wherein the metal is coated with Li₂SiOₓ, wherein X is from 2.9 to 3.0. Making an anode can be by dispersing an anode material in a solvent, wherein the anode includes silicon particles, Li₆PS₅Cl, and carbon black, placing the solvent on a disk, and heating the disk The solvent can be toluene. The silicon particles can be coated with Li₆PS₅Cl.

Described herein is a cathode that includes nickel, manganese, and cobalt, wherein the metal is coated with Li₂SiOₓ, wherein X is from 2.9 to 3.0. The metal that includes nickel, manganese, and cobalt can be LiNi_{0.8}Mn_{0.1}Co_{0.1}O₂, LiNi_{1/3}Mn_{1/3}Co_{1/3}O₂, LiNi_{0.6}Mn_{0.2}Co_{0.2}O₂, or LiNi_{0.5}Mn_{0.3}Co_{0.2}O₂. The metal that includes nickel, manganese, and cobalt can be a single crystal.

Described herein is an anode that includes silicon particles, Li₆PS₅Cl, and carbon black. The silicon particles can be coated with Li₆PS₅Cl.

Described herein is a method of making an anode material. The method can include coating silicon particles with carbon; and milling the carbon-coated silicon particles and Li₆PS₅Cl to form an anode material. Coating the silicon particles can be by mixing the silicon particles with dopamine hydrochloride to make polydopamine-coated silicon particles; and heating the polydopamine-coated silicon particles in an inert atmosphere to form carbon-coated silicon particles. Coating the silicon particles with carbon can include centrifuging the polydopamine-coated silicon particles. Coating the silicon particles with carbon can include freeze-drying the polydopamine-coated silicon particles. Heating can be to about 800° C.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 shows high energy ASLBs. The schematic representation of the high energy ASLBs is based on a Si composite anode and Li₂SiOₓ@S-NMC composite cathode.

FIG. 2 shows the general evaluation of Si anodes and Li metal anodes, including a comparison in the application of sulfide SE-based ASLBs from cost, energy densities of ASLBs, interface compatibility, and ASLBs processability.

FIGS. 3A-I show the half-cell performance of Si anode. (FIG. 3A) Schematics of the preparation process of Si-SE-CB and the configuration of Si composite anode in ASLB.

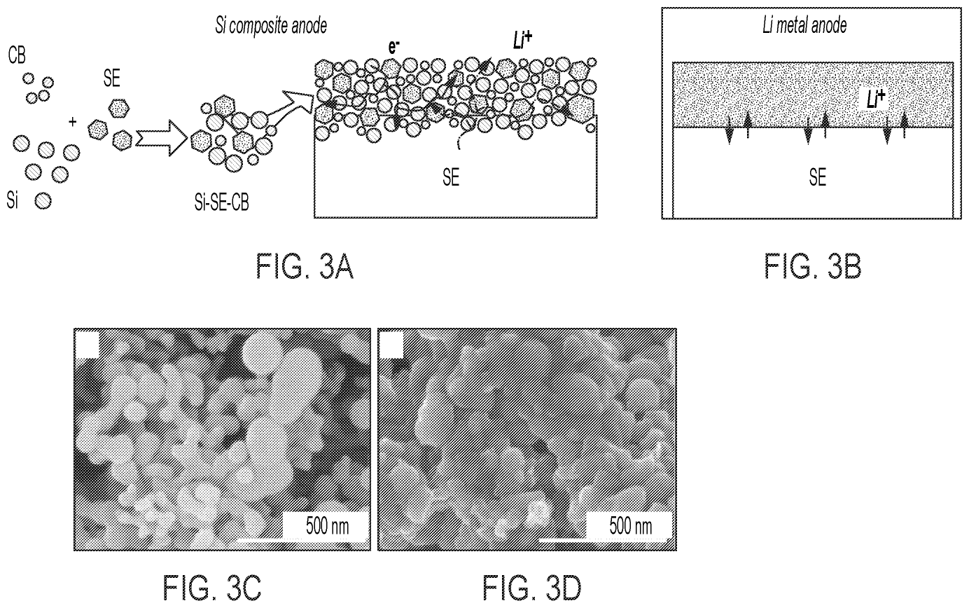

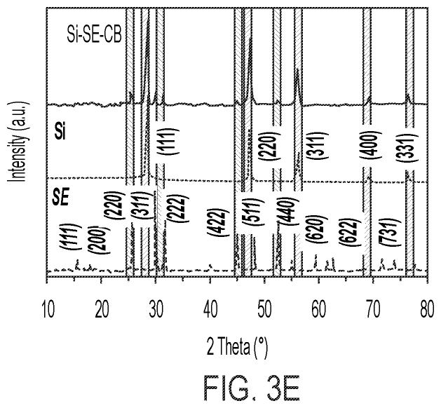

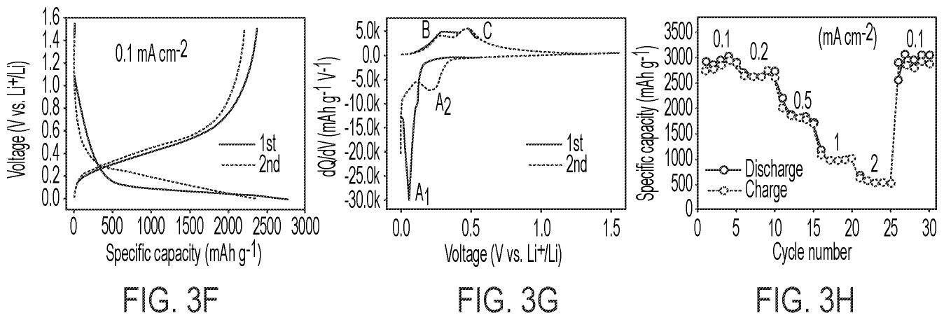

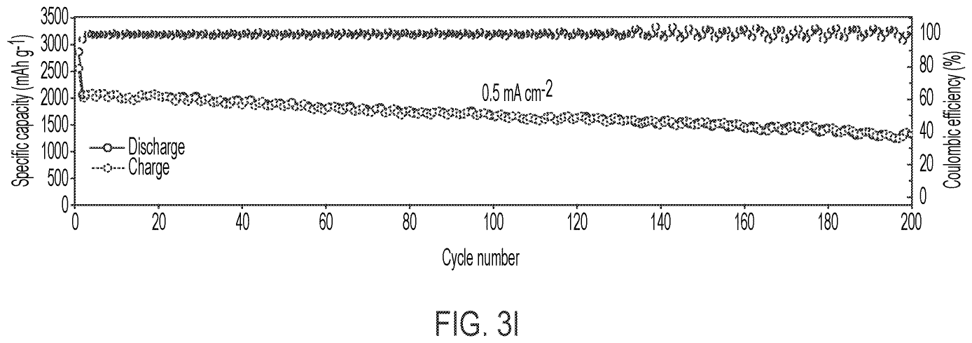

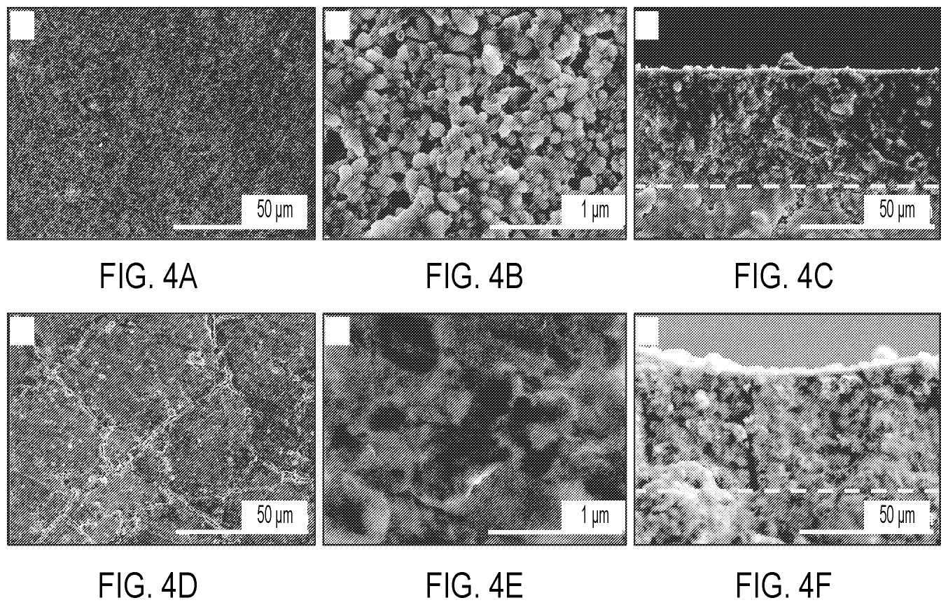

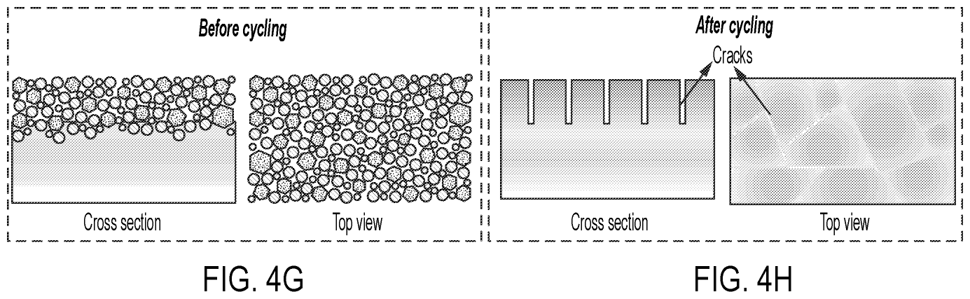

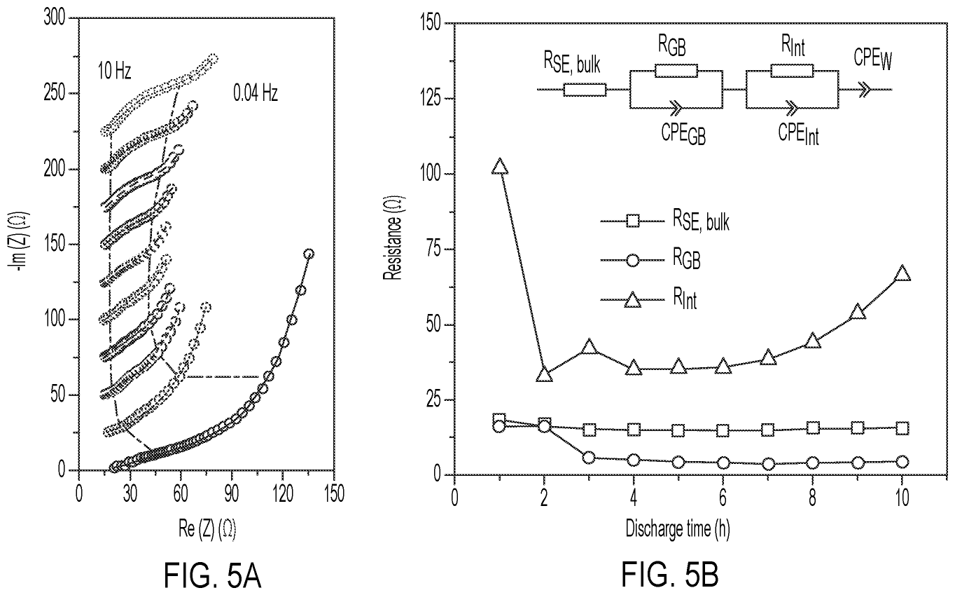

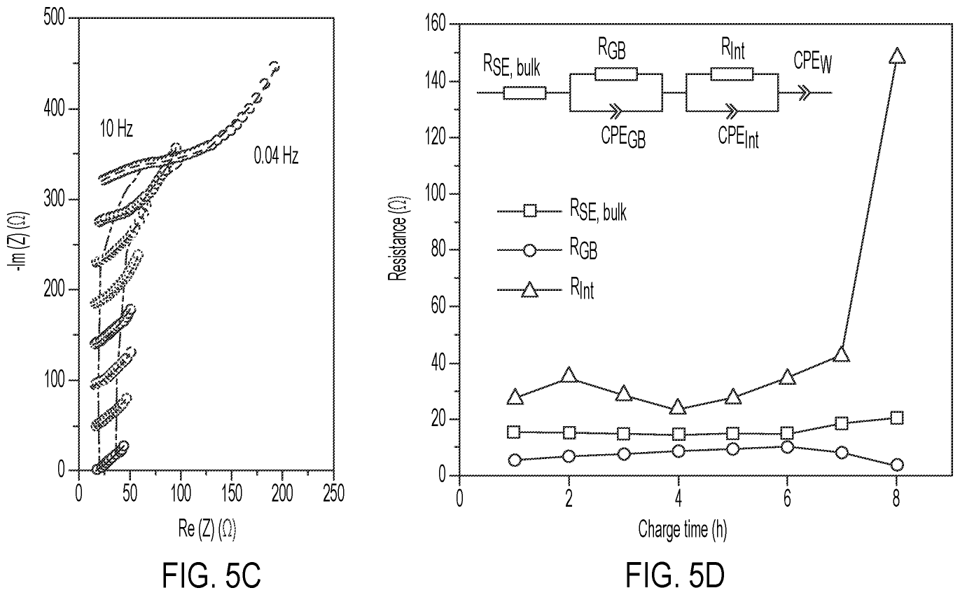

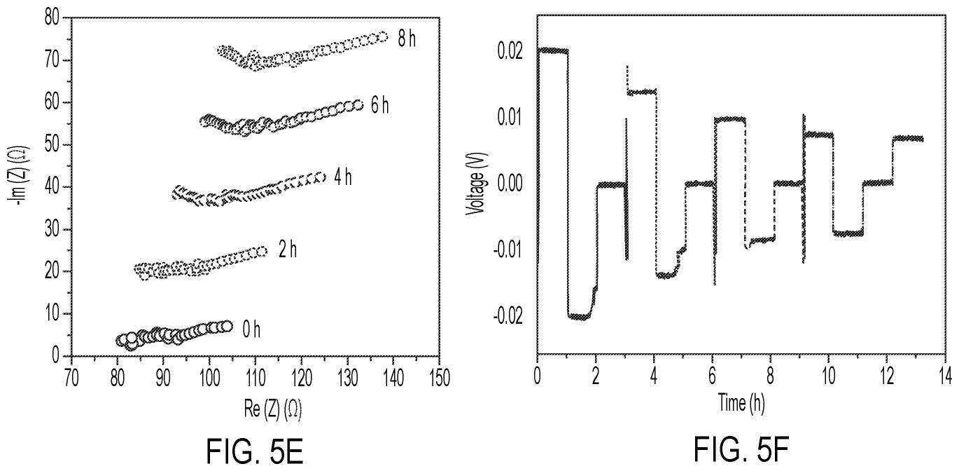

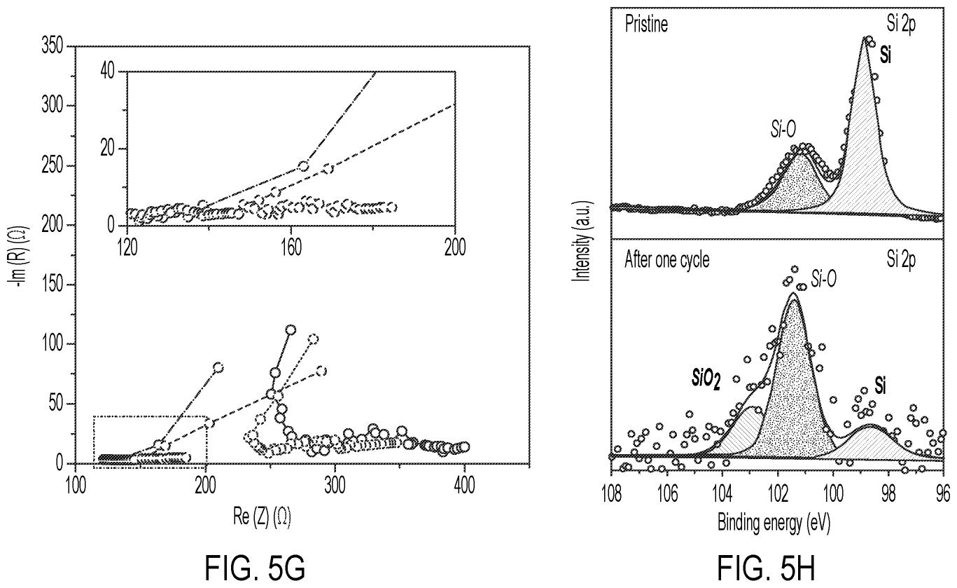

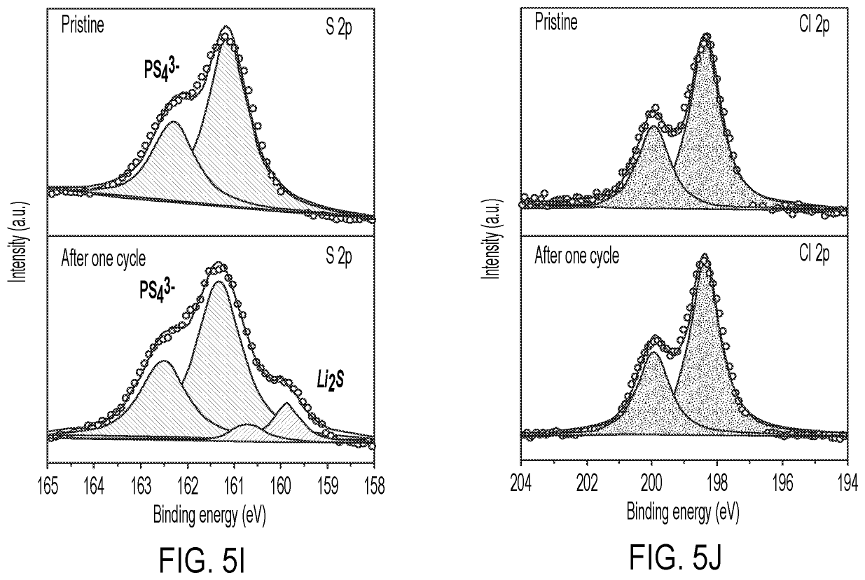

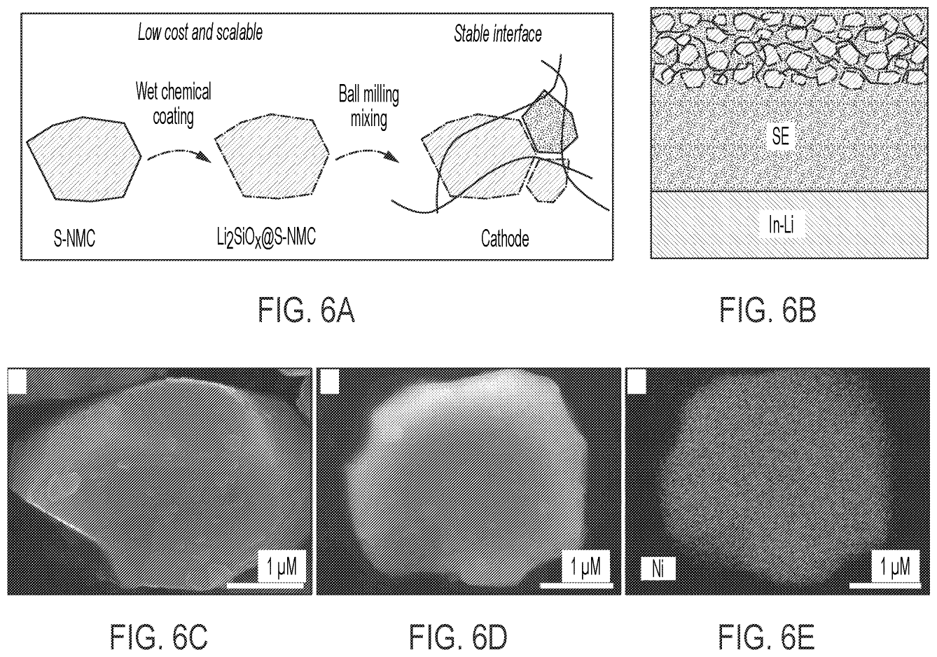

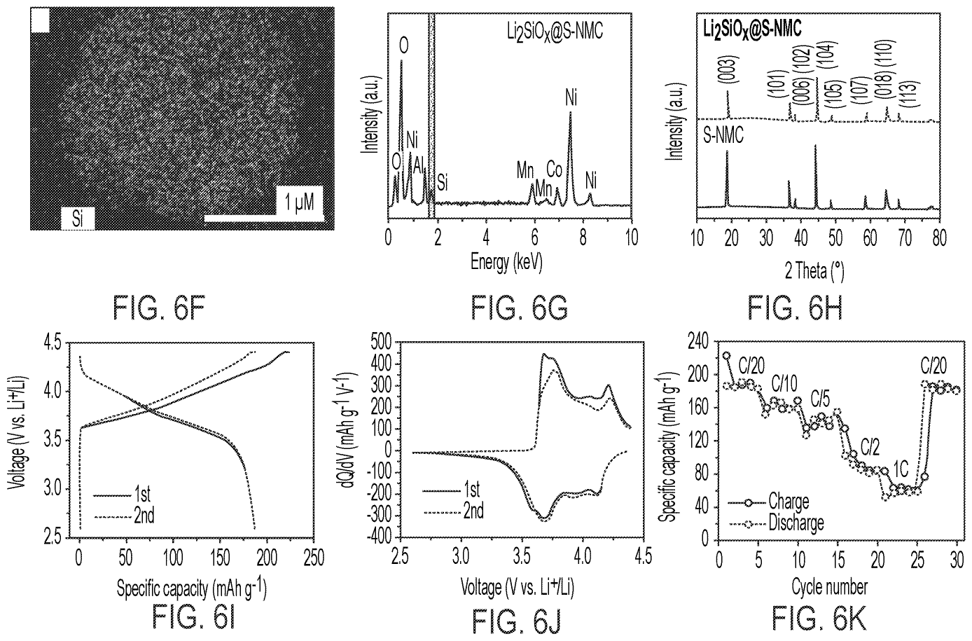

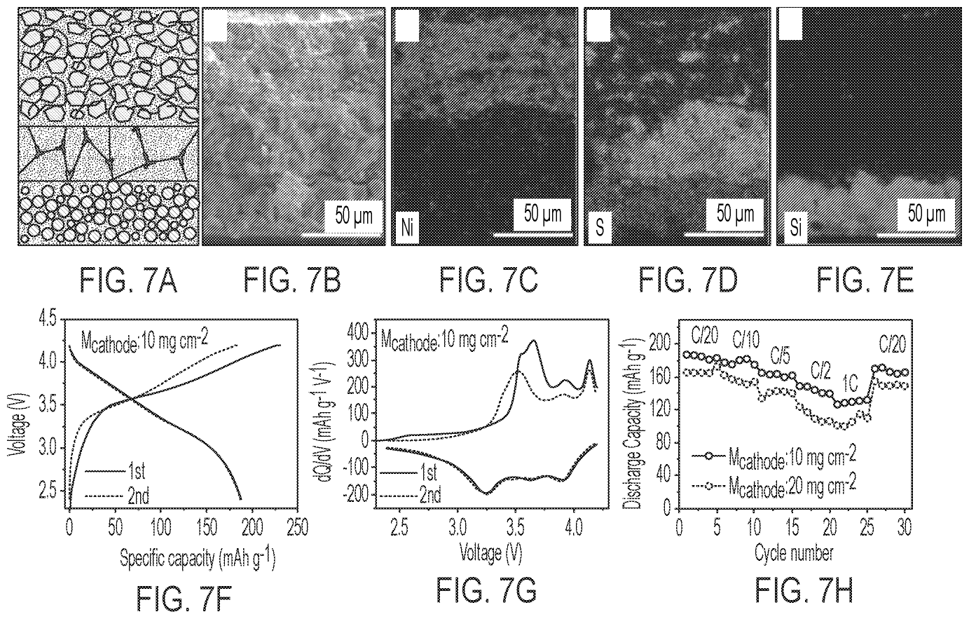

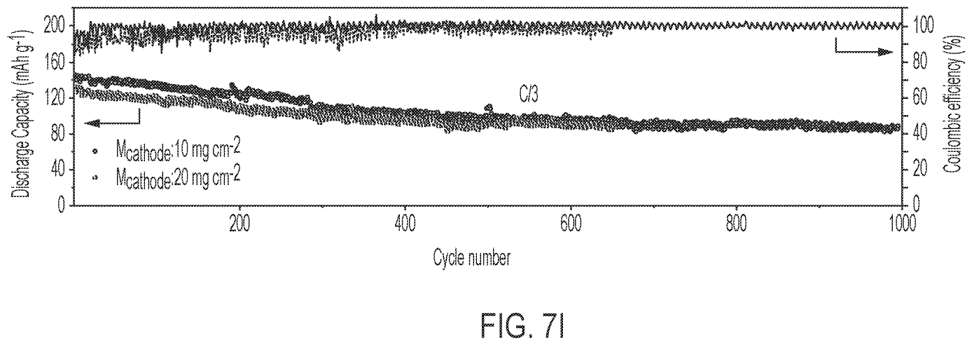

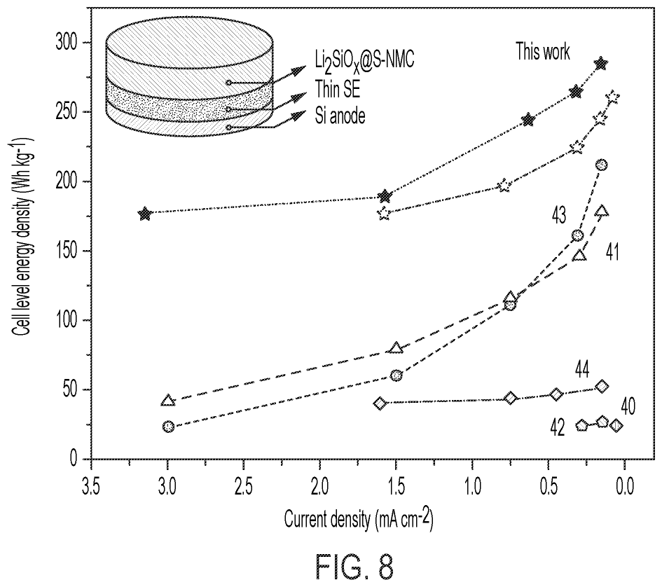

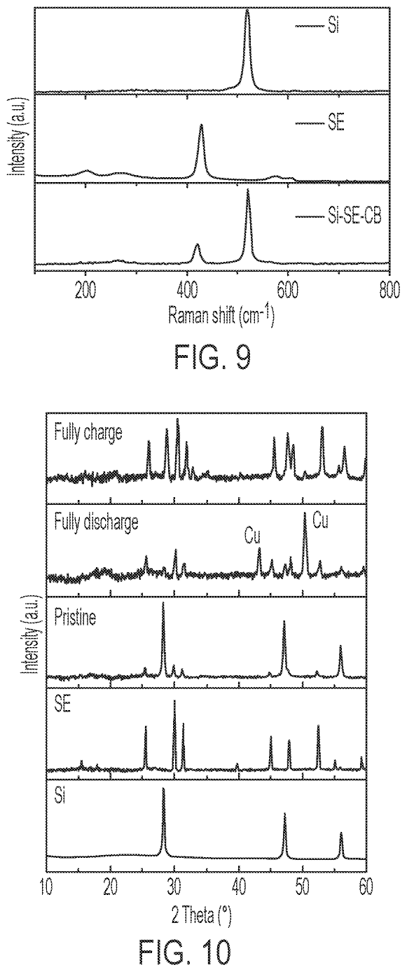

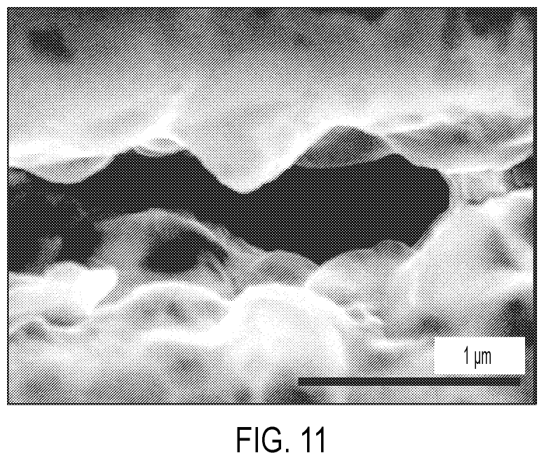

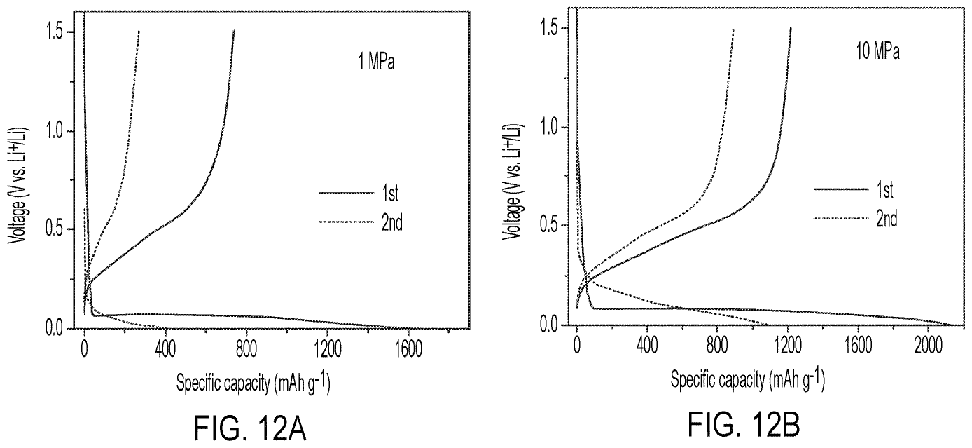

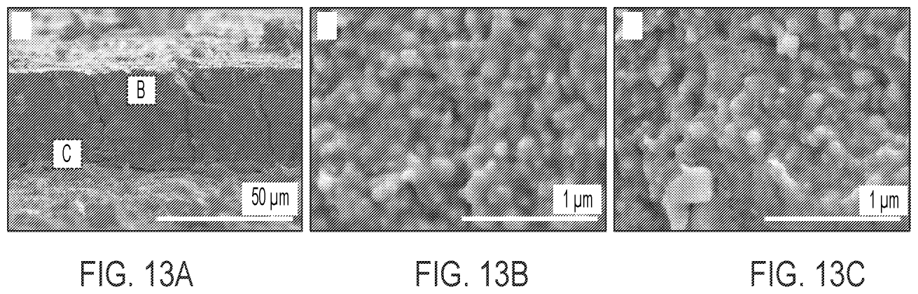

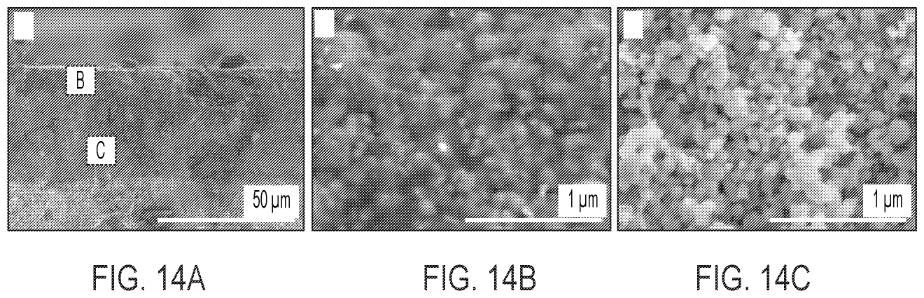

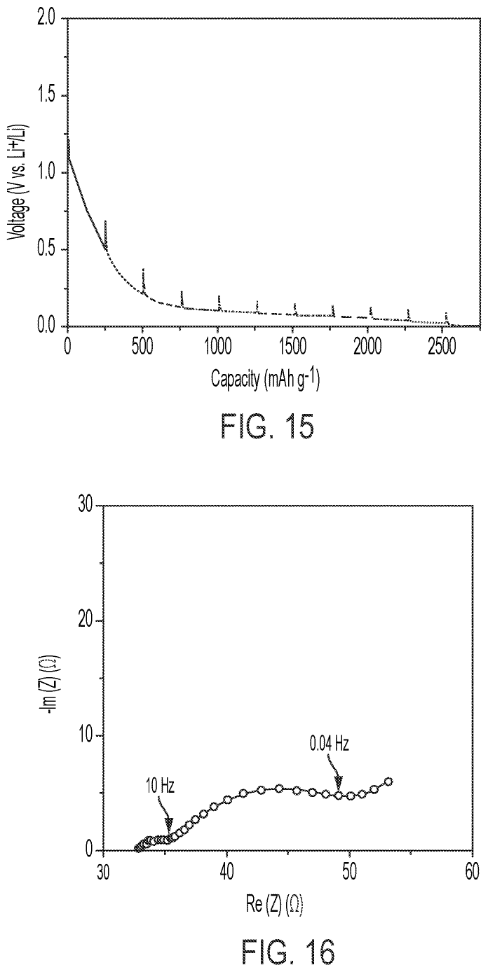

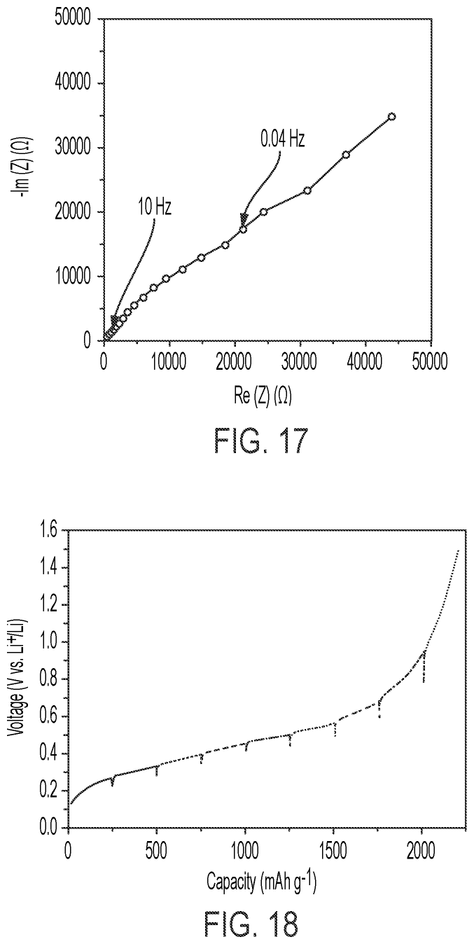

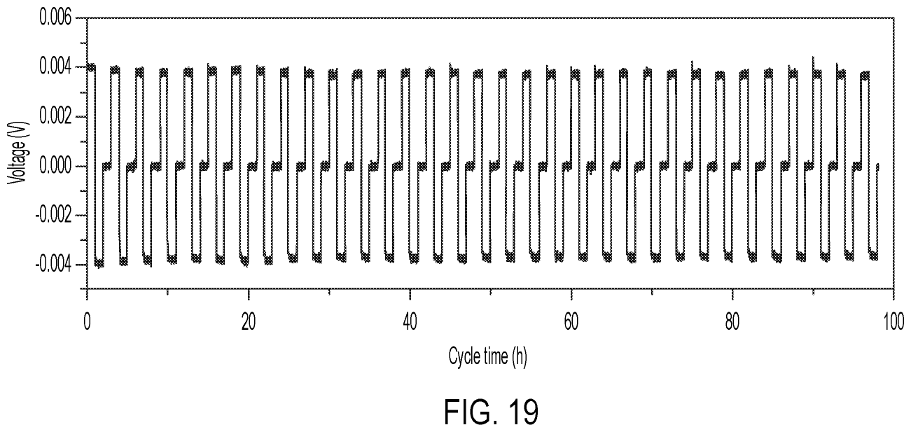

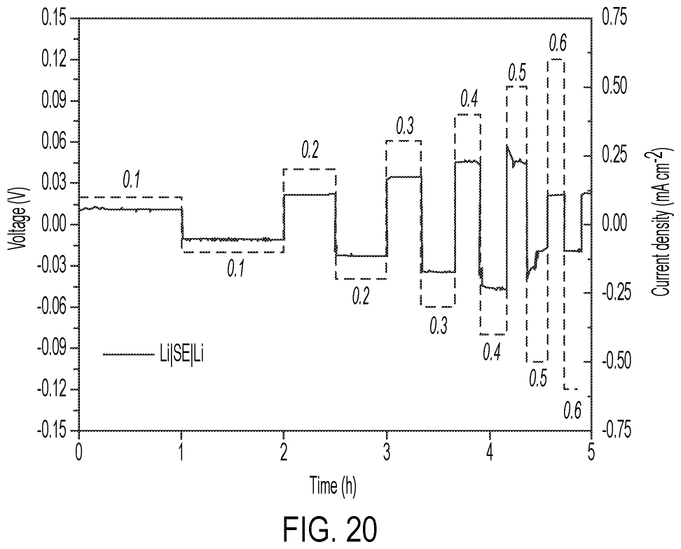

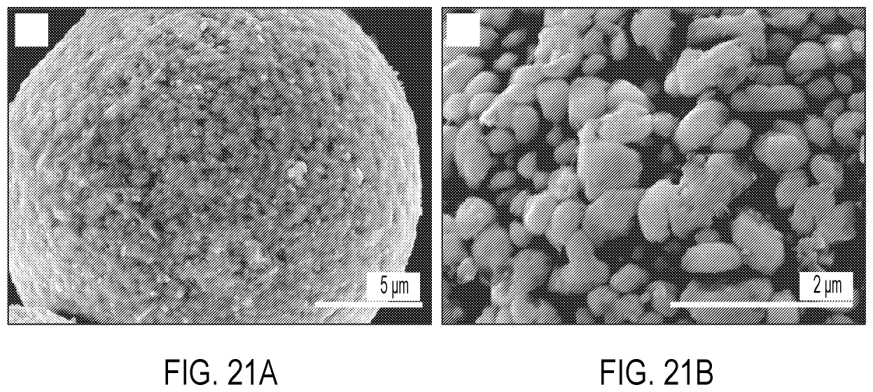

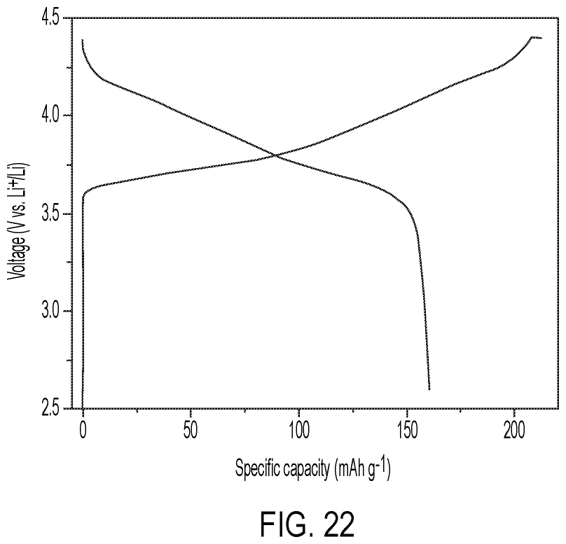

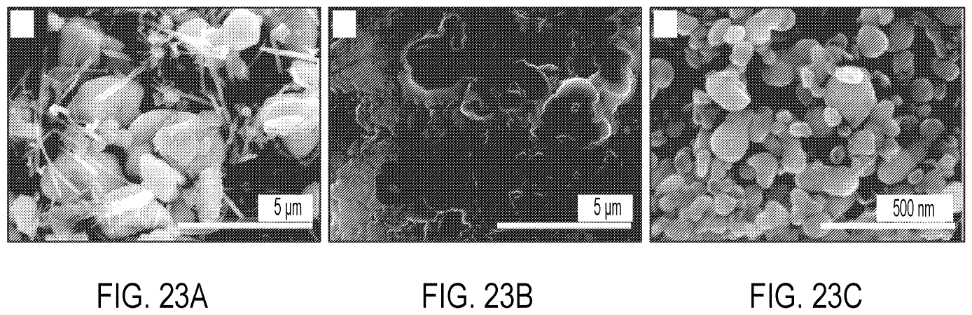

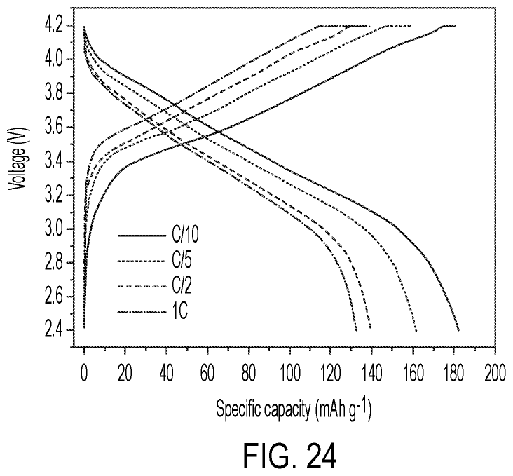

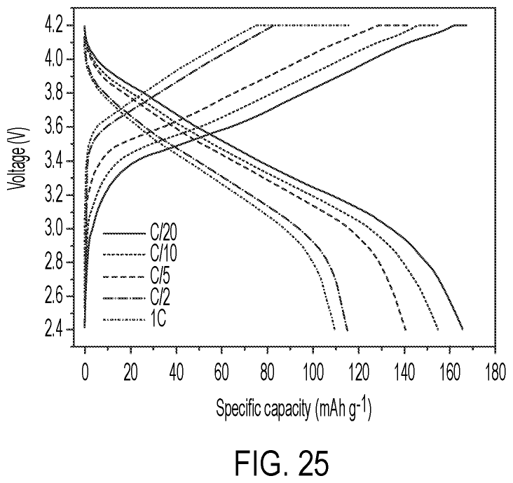

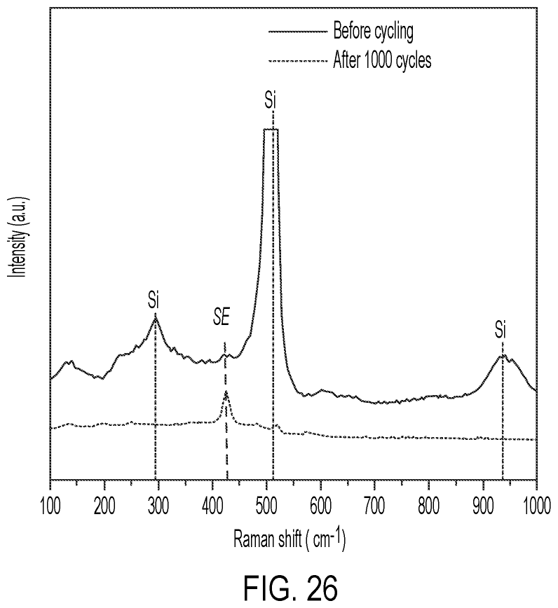

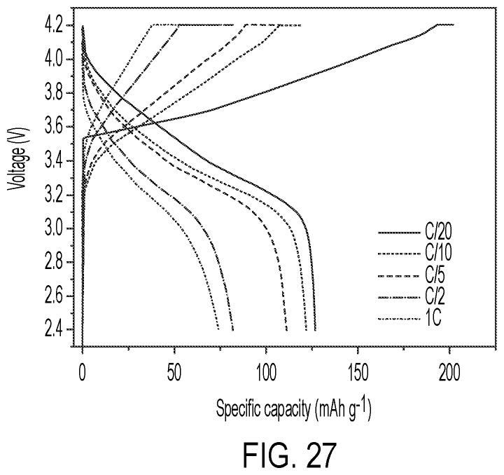

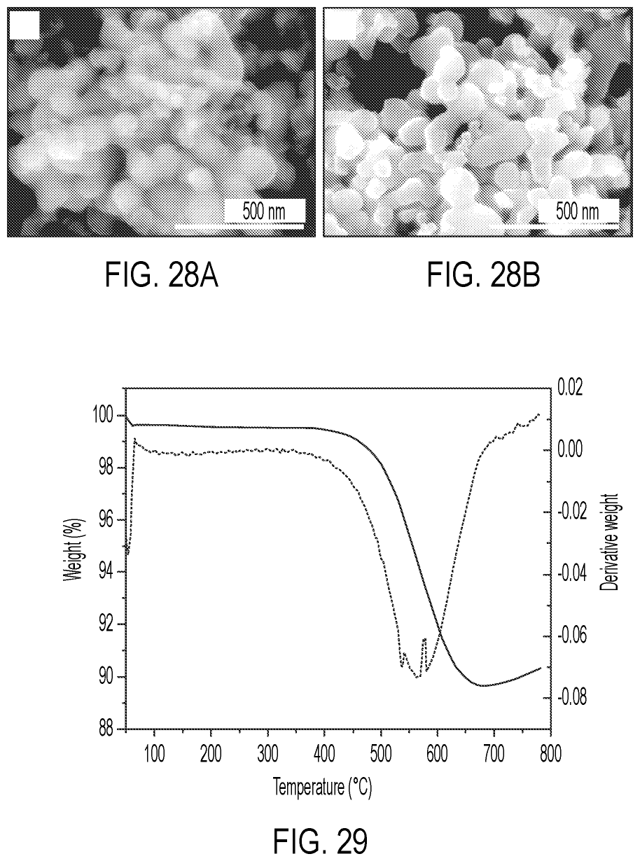

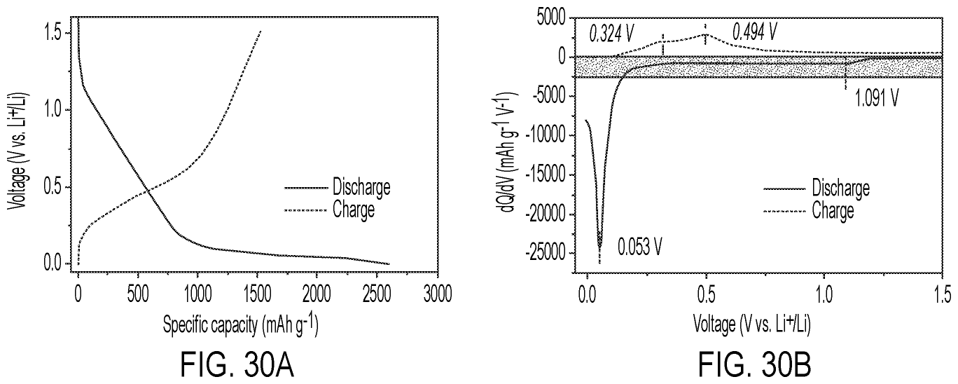

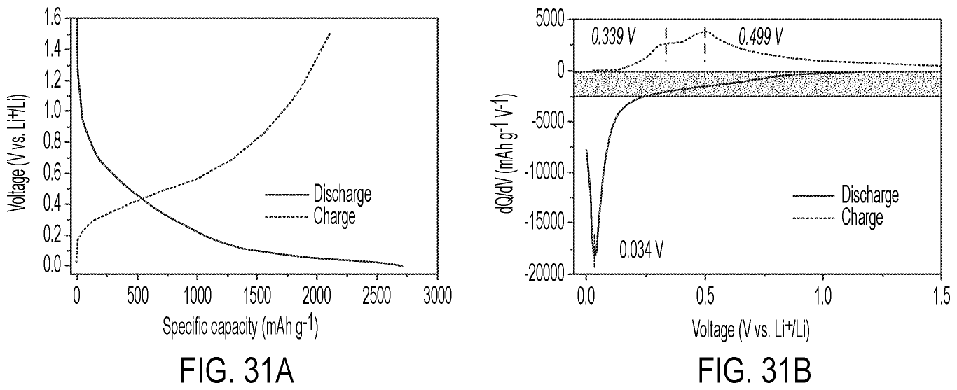

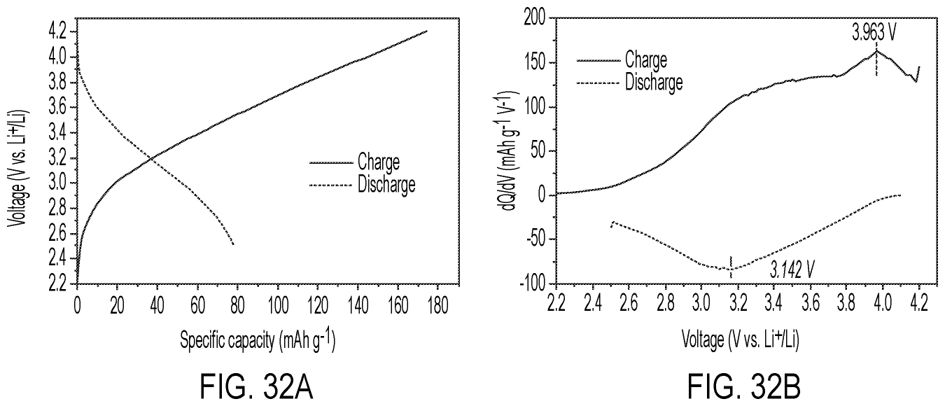

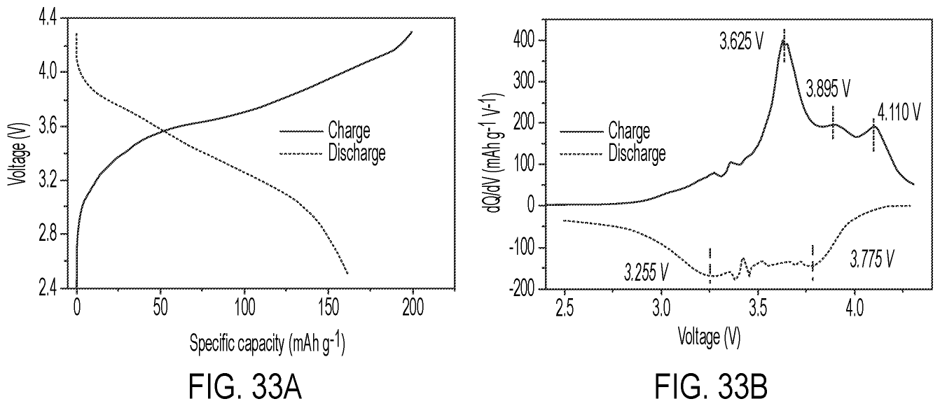

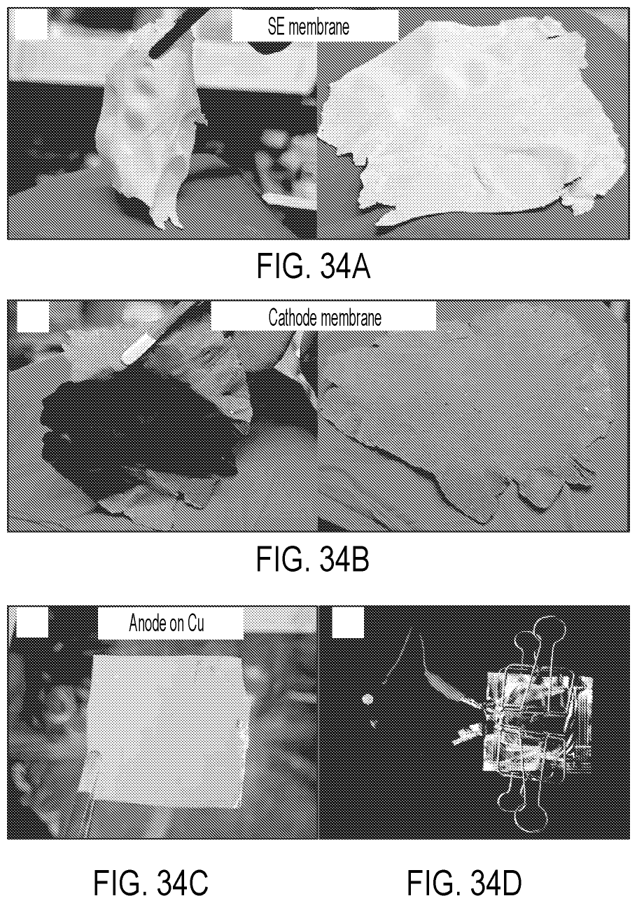

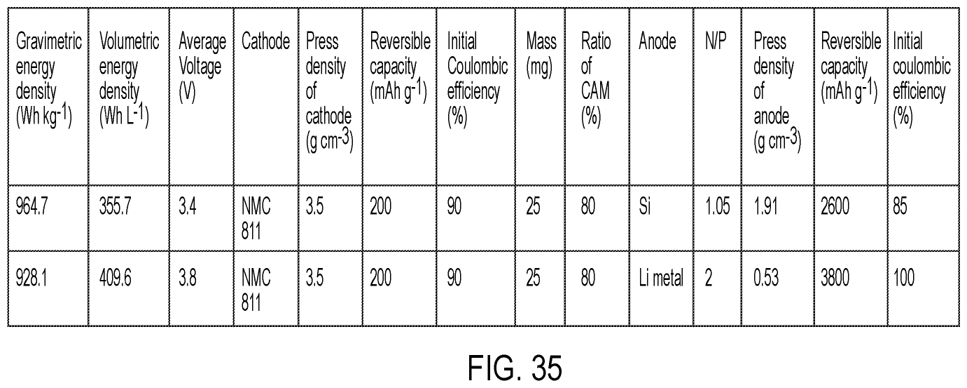

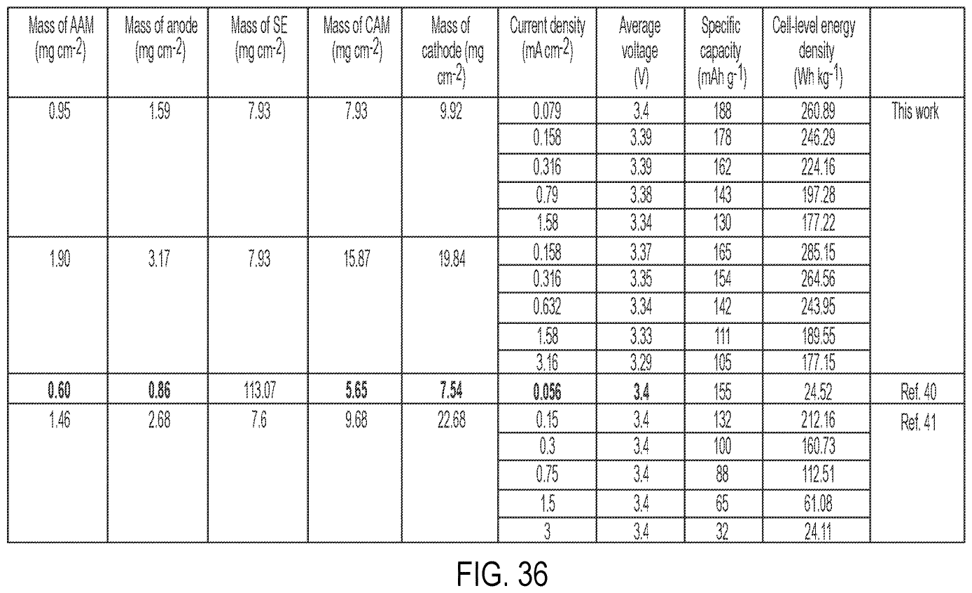

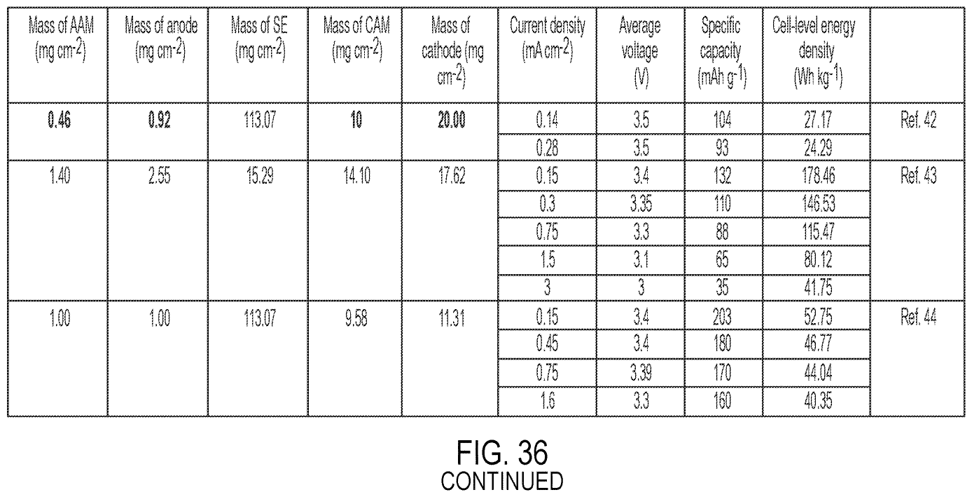

The electron and ion conduction paths are highlighted. (FIG. 3B) Schematic of Li metal anode configuration in ASLB and the ion conduction paths are highlighted. Scanning electron microscopy (SEM) images of (FIG. 3C) Si nanoparticles and (FIG. 3D) Si-SE-CB. (FIG. 3E) X-ray diffraction (XRD) of Si, SE, CB, and Si-SE-CB. (FIG. 3F) Galvanostatic charge and discharge profiles, and (FIG. 3G) Corresponding dQ/dV profiles of ASLB at the first cycle. (FIG. 3H) Rate performance of ASLB at current densities of 0.1, 0.2, 0.5, 1, and 2 mA cm-2. (FIG. 3I) Long-term cycling performance of ASLB at a current density of 0.5 mA cm⁻².

FIGS. 4A-H show the morphology evolution of Si anode after cycling. Top-view SEM images of Si composite anode before cycling in magnification of (FIG. 4A) 1 kX and (FIG. 4B) 10 kX. (FIG. 4C) Cross-section image of Si composite anode before cycling. Top-view SEM images of Si composite anode after cycling in magnification of (FIG. 4D) 1 kX and (FIG. 4E) 10 kX. (FIG. 4F) Cross-section image of Si composite anode after cycling. The vertically generated cracks are highlighted. Schematically illustration of Si composite anode (FIG. 4G) before and (FIG. 4H) after cycling in cross-section and top view.

FIGS. 5A-J show the stability investigation of Si and Li metal anodes during cycling. (FIG. 5A) Stacked Nyquist plots and (FIG. 5B) the summary of electrochemical impedance spectroscopy (EIS) results of Si anode half-cell at different discharge states during the first discharge process. (FIG. 5C) Stacked Nyquist plots and (FIG. 5D) the summary of EIS results of Si anode half-cell at different charge states during the following charge process. The inset figures in (FIG. 5B) and (FIG. 5D) are the equivalent circuit for EIS fitting. (FIG. 5E) Stacked Nyquist plots of the Li|SE|Li symmetric cell at the different resting times before cycling. (FIG. 5F) Stripping and plating curves and (FIG. 5G) corresponding Nyquist plots after every cycle of the Li|SE|Li symmetric cell at the current density of 0.25 mA cm⁻². The inset FIG. in (FIG. 5G) shows the magnified image of the area highlighted with the dashed rectangle. X-ray photoelectron spectroscopy (XPS) spectra of (FIG. 5H) Si 2p, (FIG. 51) S 2p, and (FIG. 5J) Cl 2p of Si composite anode in pristine (top) and after one cycle (bottom).

FIGS. 6A-K show the half-cell performance of Li₂SiOₓ@S-NMC cathode. Schematics of (FIG. 6A) interface engineering on single-crystal NMC 811 to make Li₂SiOₓ@S-NMC through the wet chemical coating and the preparation of Li₂SiOₓ@S-NMC composite cathode; (FIG. 6B) configuration of ASLB using Li₂SiOₓ@S-NMC composite cathode and In—Li anode. SEM images of (FIG. 6C) bare S-NMC and (FIG. 6D) Li₂SiOₓ@S-NMC. Energy dispersive X-ray spectroscopy (EDX) element mappings of (FIG. 6E) Ni and (FIG. 6F) Si in Li₂SiOₓ@S-NMC. (FIG. 6G) EDX spectrum of Li₂SiOₓ@S-NMC to show the presence of Si element. (FIG. 6H) XRD of S-NMC and Li₂SiOₓ@S-NMC. (FIG. 6I) Galvanostatic charge and discharge profiles and (FIG. 6J) corresponding dQ/dV profiles of ASLB at the first cycle. (FIG. 6K) Rate performances of ASLB at C/20, C/10, C/5, C/2, and 1 C. The ASLB was measured at room temperature. Here 1 C means 200 mA g⁻¹ based on the weight of Li₂SiOₓ@S-NMC.

FIGS. 7A-I show full cell performance. (FIG. 7A) Schematic of the full cell where a thin SE membrane is utilized. (FIG. 7B) SEM image of the cross section of the full cell. EDX element mappings of (FIG. 7C) Ni, (FIG. 7D) S, and (FIG. 7E) Si in the cross section of the full cell. (FIG. 7F) The galvanostatic charge and discharge profile of full cell with cathode mass loading of 10 mg cm⁻² at first cycle at the rate of C/20, and (FIG. 7G) the corresponding dQ/dV profiles. (FIG. 7H) Rate performances and (FIG. 7I) long-term cycling performances of the full cell with cathode mass loadings of 10 and 20 mg cm⁻².

FIG. 8 shows cell-level energy density evaluation. Cell-level energy density comparison with other reported ASLBs employing Si anode at various current densities. Refs. 40-44 are listed in the References.

FIG. 9 shows Raman spectra of Si composite anode in comparison with pure Si and SE.

FIG. 10 shows XRD spectra of Si composite anode at various charge and discharge state at first cycle.

FIG. 11 shows a magnified top view of an SEM image of the crack in a Si anode after cycling.

FIGS. 12A-B show the galvanostatic charge/discharge profiles of the Si half cells cycled at the external pressures of (FIG. 12A) 1 MPa and (FIG. 12B) 10 MPa.

FIG. 13A shows a cross-section image of Si composite anode after cycling at the pressure of 10 MPa. (FIG. 13B) Zoomed-in image of the region near the current collector. (FIG. 13C) Zoomed-in image of the region near the SE layer.

FIG. 14A shows a cross-section image of Si composite anode after cycling at the pressure of 1 MPa. (FIG. 14B) Zoomed-in image of the region near the current collector. (FIG. 14C) Zoomed-in image of the region near the SE layer.

FIG. 15 shows a discharge profile of the half cell at the current density of 0.25 mA cm⁻². The EIS was measured every hour discharge. A 30-min interval was applied before the EIS test.

FIG. 16 shows a Nyquist plot of InLi|SE|InLi symmetric cell.

FIG. 17 shows a Nyquist plot of Si-SE-CB|SE|Si-SE-CB symmetric cell.

FIG. 18 shows a charge profile of the half cell at the current density of 0.25 mA cm⁻². The EIS was measured every hour discharge. A 30-min interval was applied before the EIS test.

FIG. 19 shows following cycling performance of Li|SE|Li symmetric cell. Though the Nyquist plot was not a typical behavior of short circuit, the cell was in a soft short circuit.

FIG. 20 shows critical current density measurement of Li metal anode.

FIGS. 21A-B shows SEM images of Li₂SiOₓ coated polycrystalline NMC 811 at (FIG. 21A) low and (FIG. 21B) high magnificence.

FIG. 22 shows charge/discharge profile of the ASLBs using bare single crystal NMC 811 as cathode active material.

FIGS. 23A-C show SEM images of the (FIG. 23A) composite cathode, (FIG. 23B) SE, and (FIG. 23C) composite anode in the full cell.

FIG. 24 shows the galvanostatic charge and discharge profile of full cell with cathode mass loading of 10 mg cm⁻² at first cycle at the rate of C/10, C/5, C/2, and 1 C.

FIG. 25 shows the galvanostatic charge and discharge profile of full cell with cathode mass loading of 20 mg cm⁻² at first cycle at the rate of C/20, C/10, C/5, C/2, and 1 C.

FIG. 26 shows Raman spectra of the Si composite anode before and after 1000 cycles.

FIG. 27 shows charge/discharge profiles of the full cell using pure Si as anode.

FIGS. 28A-B show SEM images of (FIG. 28A) C@Si and (FIG. 28B) LPS@Si.

FIG. 29 shows thermo-gravimetric analysis of the C@Si. The weight loss before 650° C. was mainly caused by the burning of carbon coating in the air, while the slightly weight rise was attributed to the oxidization of Si at high temperature.

FIGS. 30A-B show half-cell performance of C@Si-SE. Galvanostatic charge/discharge profiles (FIG. 30A) and (FIG. 30B) corresponding dQ/dV profiles of the half cell at first cycle.

FIGS. 31A-B show half-cell performance of LPS@Si-SE-CB. (FIG. 31A) Galvanostatic charge/discharge profiles and (FIG. 31B) corresponding dQ/dV profiles of the half cell at first cycle.

FIGS. 32A-B show full cell performance of C@Si-SE. (FIG. 32A) Galvanostatic charge/discharge profiles and (FIG. 32B) corresponding dQ/dV profiles of the full cell at first cycle.

FIGS. 33A-B show full cell performance of LPS@Si-SE-CB. (FIG. 33A) Galvanostatic charge/discharge profiles and (FIG. 33B) corresponding dQ/dV profiles of the full cell at first cycle.

FIGS. 34A-D show images of the pouch cell assembly. Photographs of (FIG. 34A) SE and (FIG. 34B) cathode membranes. (FIG. 34C) Photograph of Si anode cast on Cu foil. (FIG. 34D) Photograph of pouch cell lightening a bulb.

FIG. 35 is a table of estimated energy densities of ASLBs using Si anode and Li metal anode.

FIG. 36 is a table of cell-level energy densities of ASLBs in comparison with reported work. The values indicated by bolded text are estimated based on the description of the experiment.

### DETAILED DESCRIPTION

A description of example embodiments follows.

Anode significantly determines the energy density of all-solid-state Lithium batteries (ASLBs). Silicon (Si) and Lithium (Li) metal are two of the most attractive anodes because of their ultrahigh theoretical capacities. However, most investigations focus on Li metal; the great potential of Si is underrated. Described herein is an investigation of Si anode's stability, processability, and cost in ASLBs and compares them with Li metal. Moreover, the single-crystal LiNi_{0.8}Co_{0.1}Mn_{0.1}O₂ is stabilized with a lithium silicate (Li₂SiOₓ wherein X is from 2.9 to 3.0) through a scalable sol-gel method. ASLBs with a cell-level energy density of 285 Wh kg⁻¹ are obtained through sandwiching Si anode, thin sulfide solid-state electrolyte membrane, and interface stabilized LiNi_{0.8}Co_{0.1}Mn_{0.1}O₂. The full cell delivered a high capacity of 145 mAh g⁻¹ at C/3 and maintained stability for 1000 cycles. The methods described herein can be used to commercialize the ASLBs on a large scale with manufacturing lines for large-scale, safe, and economical energy storage.

In general, the methods described herein are suitable for use with a variety of NMC powders, such as LiNi_{0.8}Mn_{0.1}Co_{0.1}O₂, LiNi_{1/3}Mn_{1/3}Co_{1/3}O₂, LiNi_{0.6}Mn_{0.2}Co_{0.2}O₂, and LiNi_{0.5}Mn_{0.3}Co_{0.2}O₂.

### Introduction

Great efforts have been made to develop all-solid-state lithium (Li) batteries (ASLBs) because of their attractive inflammability and prospective high energy densities.^{[1]} Among various superionic conductors, sulfide solid-state electrolytes (SEs) exhibit exceedingly high room-temperature ionic conductivities (>1 mS cm⁻¹), which enables ASLBs to work without extra heating.^{[2]} However, sulfide SEs suffer from a narrow electrochemical stability window (1.7˜2.3 V, vs. Li⁺/Li) and high reactivity towards many conventional electrodes, such as transition metal oxide cathodes and Li metal anode.^{[3]} To achieve comparable or even higher energy densities than the commercial lithium-ion batteries, electrodes that exhibit high energy density and compatibility with sulfide SEs are needed.^{[4]}

The anode material strongly determines the energy densities of ASLBs. Indium (In) and the alloy of In with Li are the most employed anodes in sulfide SE-based ASLBs due to their excellent stability with sulfide and constant electrochemical potential. However, the high reduction potential of ˜0.6 V (vs. Li⁺/Li), heavy density (7.31 g cm⁻³), and high cost (150k $ ton⁻¹) of In make them challenging to be used in industrial applications.^{[5]} In addition, commercial graphite anode is criticized for its low specific capacity (372 mAh g⁻¹). As a result, tremendous efforts are being made to seek other promising anode candidates, including conversion, alloy, and intercalation types.^{[6]} Among them, Li metal and Si are two of the most attractive anode materials due to their ultrahigh energy densities.^{[7]} Li metal anode has been investigated since the invention of Li batteries because of its high specific capacity of 3860 mAh g⁻¹ and the lowest reduction potential of −3.04 V (vs. Standard Hydrogen Electrode). Nevertheless, the safety concerns caused by severe dendrite growth have highly restricted its commercialization.^{[8]} For a long time, the rigid SEs were thought to revive the use of Li metal anode in ASLBs to deliver ultrahigh energy densities.

However, studies revealed that Li metal application in ASLBs faces various challenges, like the unstable interface, low critical current density, and strict operating conditions.^{[9]} When using metal sulfide as SEs, interface chemical, electrochemical, and mechanical stability between Li metal and SE are major concerns. Numerous efforts, like the introduction of an interface protection layer, optimization of SEs to generate a more stable solid electrolyte interphase (SEI), and the employment of additives in Li metal to adjust the deposition behaviors, have been committed to stabilizing the interface. However, there is still a long way to commercialize the ASLBs coupling Li metal anode with sulfide SEs in large-scale manufacturing, which needs to tackle the interface reaction issues and have challenges adopting Li metal into the existing manufacturing lines.^{[10]}

As a typical alloy-type anode, Si has an ultrahigh room-temperature theoretical capacity of 3590 mAh g⁻¹, about ten times higher than the conventional graphite.^{[11]} The reduction potential is ˜0.4 V (vs. Li⁺/Li) on average, avoiding the risk of Li dendrite formation.^{[11]} Moreover, Si is one of the most abundant elements on Earth and very affordable. Si anode thus attracts tremendous interest from industries.^{[12]} However, the commercialization of Si anode is challenged by its colossal volume change (˜300%) during cycling and low electrical conductivity.^{[12]} The significant volume expansion and shrink create enormous mechanical stresses causing the break and pulverization of the electrodes. As a result, the battery capacity decays rapidly. Many strategies, such as designing nanostructures, introducing electrolyte additives, optimizing binders, and compositing with other materials, have been proposed to solve the challenges in liquid electrolytes for commercializing Si anode.^{[7]} However, the application of Si anode in sulfide SE-based ASLBs lacks investigation. Lee et al. reported sulfide SE-based ASLBs using Si composite anodes with Si particle size ranging from nano-to micro-scales and investigated the effect of carbon additives and external pressure.^{[13]} Takada et al. fabricated thin Si films through thin-film fabrication approaches and applied them in ASLBs.^{[14]} Though excellent rate performance was achieved in these works, the mass loading of active material was low (<0.23 mg cm-2), limiting the energy densities of ASLBs. The reported ASLBs exhibited short cycling life (<100 cycles) and limited cell-level energy density (<225 Wh kg⁻¹, excluding the fraction of current collectors and packages). Meng et al. recently reported a representative work that used pure micro-Si as anode and the ASLB delivered excellent cycling stability and performance. However, the cell-level energy density is not high due to the employment of a thick SE layer.^{[15]}

Described herein are a systematic evaluation of Si and Li metal anodes in sulfide SE-based ASLBs. A composite of nano Si, Li₆PS₅Cl, and carbon conductive was employed as the anode achieving ASLBs with outstanding cell-level energy densities. The composite anode was prepared through a large-scale ball milling method and delivered stable cycling performance. In addition, interface coatings on Si, including fabricating ion-conductive and electron-conductive layers, were investigated. On the cathode side, single-crystal LiNi_{0.8}Mn_{0.1}Co_{0.1}O₂ (S-NMC811) was utilized as the cathode active material. A scalable interface stabilization of S-NMC with a thin layer of lithium silicate (Li₂SiOₓ) was adopted to alleviate the side reaction between NMC and sulfide SE. To increase cell-level energy density further and reduce the internal resistance, a thin SE layer with thickness lower than 50 μm was investigated as the ionic conductive membrane. As a result, the ASLBs exhibited remarkable cell-level energy densities of 285 Wh kg⁻¹ and 177 Wh kg⁻¹ at current densities of 0.158 mA cm⁻² and 3.16 mA cm⁻², respectively. When cycled at C/3, the cell delivered a high specific capacity of 145 mAh g⁻¹ and maintained stability for 1000 cycles.

### EXEMPLIFICATION

### Results and Discussion

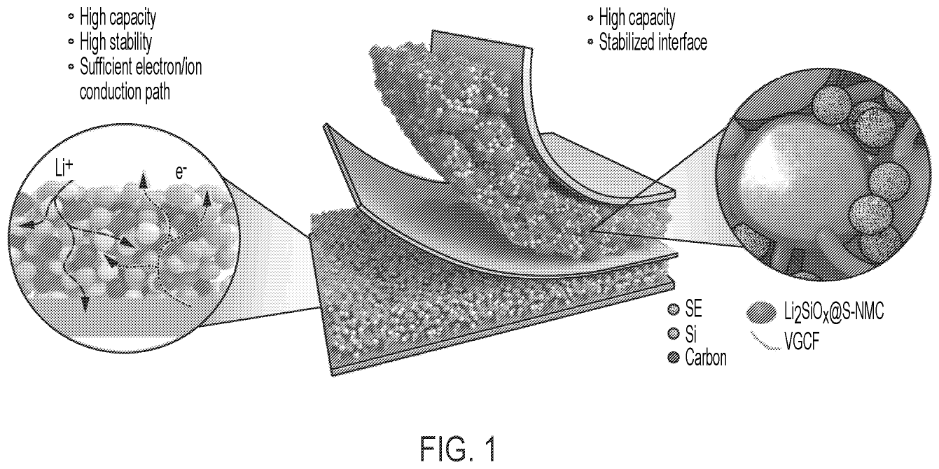

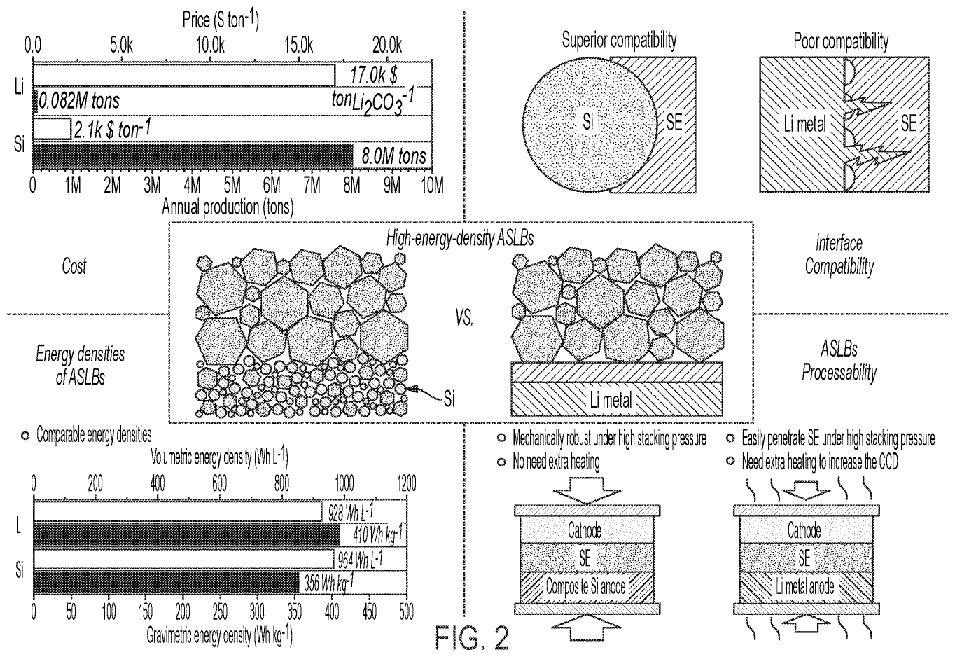

A high-energy ASLB based on a Si composite anode, Li₂SiOₓ coated S-NMC (Li₂SiOₓ@S-NMC) composite cathode, and a thin sulfide SE membrane were designed, which showed great potential in industry application. As illustrated in FIG. 1, a sheet-type ASLB was developed. Si nanoparticles were uniformly mixed with carbon black and sulfide SE, which fabricated sufficient electron and ion conduction pathways in the anode. In the cathode, a thin layer of Li₂SiOₓ coating effectively stabilized the interface between S-NMC and sulfide SE, which contributed to a high capacity. In addition, an ASLB with cell-level high energy density was successfully assembled utilizing a thin SE membrane. Given the excellent air stability of Si, the anode fabrication could be processed in a dry room but not limited to the glovebox. In contrast, Li metal anode is limited to the glovebox with a high-cost Argon atmosphere. With Si as an anode, the fabrication process could be easily carried out in the modified production line for current lithium-ion batteries (LiBs). The Si anode based ASLBs are extremely promising to be applied in large-scale energy storage applications, like electric vehicles, to provide high energy density, safe, reliable, long-life, and economically affordable energy storage.

FIG. 2 comprehensively compares the applications of Si anodes and Li metal anodes in sulfide SE-based ASLBs from these four aspects: cost, energy densities, interface compatibility, and processability. First, reducing the cost of batteries is critical for commercialization. Li is not abundant on Earth, with a worldwide annual mine production of only 0.082 million tons in 2020 (excluding U.S. production).^{[5]} As the global demand significantly rises, the price of battery-grade lithium carbonate has reached as high as 17.0k $ ton⁻¹ as of 2018.^{[5]} In comparison, Si is highlighted with large abundance and low cost. The annual production can reach 8.0 million tons, and the price of Si metal is only 2.1k $ ton⁻¹.^{[5]} In the long term, Si anode is cheaper than Li metal anode in developing large-scale, low-cost ASLBs.

Secondly, the energy densities of ASLBs using Li metal and Si anode are evaluated. Excluding the fractions of the current collectors and packing material, the ASLBs using Si anode exhibit gravimetric and volumetric energy densities of 356 Wh kg⁻¹ and 965 Wh L⁻¹ individually, which are comparable with Li metal anode (410 Wh kg⁻¹ and 928 Wh L⁻¹). It should be noted that the calculation was based on experimental results from the literature, and the details are listed in the table of FIG. 35.

Thirdly, the compatibility of Si and Li metal anodes toward sulfide SE is compared. Li metal suffers from severe chemical reactions with most sulfide SEs resulting in interphase formation with low ionic conductivities. More seriously, Li metal has intense dendrite growth and very low critical current density (<0.2 mA cm⁻² for bare Li metal) at room temperature. An interface stabilization is often used between Li metal and sulfide SE, most of which is challenging when applied in large-scale manufacturing. In comparison, Si is thermodynamically stable with sulfide SEs, and no passivation coatings are needed to insulate Si and sulfide SE. The high working potential of Si lowers the dendrite formation risk.

Fourthly, the processibilities of ASLBs using both anodes are evaluated separately. Generally, a high stacking pressure is applied in fabricating ASLBs to achieve intimate contact between electrodes and electrolytes.^{[16]} However, Li metal easily propagates through the SE under pressure larger than 25 MPa and causes a short circuit.^{[17]} In contrast, Si has a high Young's modulus of 130 GPa and is dimensionally stable under high pressure.^{[18]} Additionally, Li metal-based ASLBs usually need extra heating to improve the reaction kinetics and increase the critical current density. In comparison, Si anode exhibits good room-temperature performance even at a high current density. It is also well known that Li is active in the ambient environment and must be manufactured inside the glovebox. In contrast, Si is stable in the ambient environment for large-scale manufacturing.

More importantly, Si powder with a high surface area enables mixing the Si with both carbon and SE, which increases the effective electrochemical reaction area, increases the total current density, and reduces local current density. The current density in reported work can reach 10 mA cm⁻², demonstrating superior compatibility and perspective high power.^{[19]} It is challenging to mix the Li with SE homogeneously with Li metal anode to obtain a similar effect. From the abovementioned comparisons, it was concluded that the Si anode was highly promising in sulfide SE-based ASLBs for large-scale manufacturing and commercialization before the challenges in Li metal were addressed.

Si was reported with low electrical conductivity (<10⁻⁵ S cm⁻¹) and low ion diffusivity.^{[13]} Therefore, a simple approach to improving Si anode's performance involves compositing with SEs and conductive additives. Herein, to demonstrate the excellent processability of Si anode, a facile ball milling method was utilized to synthesize the Si composite anode for ASLBs, as depicted in FIG. 3A. Si nanoparticles, SE, and carbon black (CB) were mixed in a weight ratio of 6:3:1 through a ball milling at 400 rpm for two hours. Si nanoparticles with a particle size of 50˜100 nm were used as the active material. The argyrodite-type Li₆PS₅Cl worked as the SE due to its high ionic conductivity of ˜2 mS cm⁻¹. The commercial CB was selected as the conductive additive. Due to the ionic and electronic insulating, binder is not used in the electrodes. Electron and ion conduction paths were well established in the whole electrode due to the large contact area between Si with SE and CB, which boosts the critical current density of the anode. In contrast, as illustrated in FIG. 3B, Li metal experienced a relatively low contact area with SE which caused limited critical current density.

FIG. 3C shows the scanning electron microscopy (SEM) image of Si nanoparticles with spherical morphology and particle size ranging from 50 to 100 nm. After the ball milling, Si, SE, and CB were uniformly mixed. As depicted in FIG. 3D, the Si nanoparticles maintained their spherical morphology and were mixed with a mud-like SE. The homogeneous mixing with SE and CB benefited the ion and electron conduction in the Si anode. FIG. 3E reveals the X-ray diffraction (XRD) patterns of Si, SE, and Si-SE-CB. The nano-Si showed sharp diffraction peaks at 28.4°, 47.3°, 56.1°, 69.1°, and 76.3°, which demonstrated a high degree of crystallinity. The Li₆PS₅Cl showed typical diffraction patterns of argyrodite, and no impurities were found. In Si-SE-CB, all diffraction peaks were indexed to the crystalline Si and argyrodite Li₆PS₅Cl, which demonstrated the chemical stability between Si and SE. FIG. 9 shows the Raman spectra of Si-SE-CB. No newborn peaks were found in Si-SE-CB, demonstrating excellent chemical stability among the three components.

The performance of the Si-SE-CB was first investigated in a half cell where In—Li acted as the counter electrode. The current density of 0.1 mA cm⁻² and the voltage range of 0˜1.5 V (vs. Li⁺/Li) were applied. FIG. 3F depicts the galvanostatic charge and discharge profiles of the half-cell ASLBs of Si anode at the first two cycles. High discharge and charge capacities of 2773 and 2373 mAh g⁻¹ (corresponding to 2.64 and 2.26 mAh cm⁻²) were achieved at the first cycle, and the initial coulombic efficiency (ICE) was as high as 85.6%. During the first discharge, one long plateau lower than 0.2 V appeared, representing the gradual lithiation process of crystalline Si. There was no apparent plateau, but a slope was found in the charging process suggesting the complex dealloying of Li ions from different LiSi alloy (LiₓSi) phases. In the following cycle, the discharge profile was significantly different. The voltage gradually reduced, and a slope with an onset potential higher than 0.25 V was observed, representing the lithiation process of amorphous Si.^{[11]} It demonstrated the amorphization of Si at the first cycle.

The differential capacities with cell potential were plotted to analyze the electrochemical reaction processes further, as shown in FIG. 3G. At the first discharge, a prominent peak was observed at 0.057 V with an onset potential of 0.180 V, corresponding to the plateau in FIG. 3F. This process was explained by forming metastable amorphous LiₓSi by a solid-state amorphization reaction.^{[20]} No pronounced peaks were observed before discharging to 0.2 V, suggesting the decomposition of SE was ignorable. In the following dealloying process, two broad oxidation peaks at 0.303 and 0.474 V were observed and ascribed to the phase transformations processes from Li_{3.17}Si to Li₇Si₃ and then to LiSi.^{[21]} In contrast, two peaks located at the 0.219 V and ˜0.01 V at the second discharge process corresponded to the converse transformations from LiSi to Li₇Si₃ and then to Li_{3.17}Si.^{[21]} The broad peak at 0.219 V signaled the alloying process of amorphous Si. The oxidation peak in the following charge process was similar to the first cycle. FIG. 10 compares the XRD of Si composite anode in pristine, fully discharged and fully charged states. The dramatically reduced Si peak intensity demonstrated the amorphization process of Si during cycling.

Briefly, the crystalline Si nanoparticles experienced an amorphization during the first cycle with the transformation between different LiₓSi phases.

FIG. 3H shows the rate performance of the Si composite anode at current densities of 0.1, 0.2, 0.5, 1, and 2 mA cm⁻², and the corresponding average capacities are 2309, 2122, 1467, 802, and 440 mAh g⁻¹, respectively. Here, 2 mA cm⁻² equals 1.71 C, based on the theoretical room-temperature capacity of 3590 mAh g⁻¹. This current density greatly exceeded most reported critical current densities of Li metal towards sulfide SE, demonstrating the superiority of Si to Li metal incompatibility with sulfide SEs. FIG. 3I displays the long-term cycling performance of the Si composite anode at the current density of 0.5 mA cm⁻². The ASLB displayed remarkable specific discharge and charge capacities of 2067 and 1997 mAh g⁻¹ individually. After 200 cycles, there were still ultra-high capacities of 1345 and 1316 mAh g⁻¹ remaining. Notably, the counter electrode (In—Li) used here may slightly affect the cycling stability due to the cavities or voids formed at the interface between In—Li and SE at high currents.^{[22]}

The morphology evolution of the composite anode before and after the rate performance was investigated by the SEM to analyze the electrochemical behavior further. FIG. 4A shows the top view morphology of the composite anode before cycling. After being stacked on the SE layer at high pressure (300 MPa), the electrode showed a uniformly flat surface without large cracks or voids. When further magnified in FIG. 4B, it is clear that the granular Si and the muddy SE-CB matrix were uniformly mixed, and some tiny pores existed in the electrode. The samples were cut with a REXBETI single edge razor blade to check the cross-section morphology. The cross-section image in FIG. 4C shows that the electrode is well integrated with the SE layer, and no large cracks or voids were observed. After cycling, the morphology varies significantly. FIG. 4D depicts the top view morphology of the electrode at the same magnification as FIG. 4A. The electrode surface was still smooth, but many reticular cracks were observed. The cracks exhibited lengths greater than 50 μm and widths less than 1 μm (FIG. 11). Though cracks appeared, the electrode maintained integrity without breaking. FIG. 4E magnifies the surface of the electrode. Surprisingly, the granules and pores disappeared but were replaced with a dense and homogeneous morphology. FIG. 4F displays the cross-section morphology of the electrode after cycling. There were apparent vertically growing cracks observed corresponding to the reticular cracks in the top view. However, there is no delamination between the electrode and SE layer which avoided the failure of the ASLB.

The morphology evolution is schematically illustrated in FIGS. 4G-H from the top view and cross section. After cycling, the granulate morphology of the composite transferred into a dense and homogeneous morphology, while some vertically growing cracks were generated. According to the electrochemical behaviors, the Si experienced an amorphization during cycling, which explained the transformation in morphology. There were no significant changes in SEs, indicating that the amorphization of Si likely caused the morphology evolution. This dense and homogeneous electrode benefited the Si with high electron and ion accessibility and buffered the Si volume expansion, which contributed to stable cycling. At the same time, the considerable volume change of Si during alloying and dealloying processes may have brought great strain to the electrode and caused the generation of vertical cracks. These vertical cracks have been reported in ASLBs using micro-Si as the anode, and the gaps are considered to buffer the volume change during the lithiation process of Si.^{[22]} In addition, the intimate contact between the electrode and SE layer provided sufficient electron and ion conductions which explained the long-term cycling life of the ASLBs.

The external pressure is critical for the Si anode in ASLBs. Two Si anode half cells were cycled individually under external pressures of 1 MPa and 10 MPa. As shown in FIG. 12A, the cell operated under 1 MPa delivered an initial discharge capacity of 1684 mAh g⁻¹ with a low ICE of 43.8%, while the cell operated under 10 MPa (FIG. 12B) showed a higher discharge capacity of 2135 mAh g⁻¹ and ICE of 56.9%. However, the capacities in both cells decreased quickly. Compared with the cell measured at 50 MPa, the capacity and cycling stability was lower. FIGS. 13A-C and FIGS. 14A-C show the SEM images of the Si anode half cells cycled under the pressure of 1 MPa and 10 MPa, respectively. In the cell measured at 10 MPa, vertical cracks were observed, and the Si showed an amorphous morphology at the whole electrode. However, in the cell measured at 1 MPa, the Si anode displayed amorphous in the region close to the current collector and nanoparticles in the area close to the SE, demonstrating the nonuniform electrochemical reaction and low utilization of Si during the cycling. It proved that external pressure leads to high Si utilization and cycling stability. However, external pressure settings reduced the cell-level specific energy in practice applications. Therefore, engineering advanced cell designs was needed for sulfide based ASLBs.

To further investigate the stability of the Si anode and Li metal anode during cycling, the evolution of the impedances at different charging states wad tracked. FIG. 15 displays the discharge profile of the Si anode half-cell at 0.25 mA cm⁻² while the impedance was measured every hour. A 30-min. interval was applied before the EIS test. FIG. 5A shows the stacked Nyquist plots at various discharge states, and the points at frequencies of 10 Hz and 0.04 Hz are highlighted as dashed lines. EIS spectra maintained a similar shape consisting of a depressed semicircle from 10 Hz to 0.04 Hz and a Warburg tail at low frequencies. Overall, the total resistance decreased first and then increased. The EIS of the In—Li|SE|In—Li and Si-SE-CB|SE|Si-SE-CB symmetric cells were investigated to elucidate the root of the impedances (FIG. 16 and FIG. 17). In the frequency range from 10 Hz to 0.04 Hz, both In—Li|SE|In—Li and Si-SE-CB|SE|Si-SE-CB showed incomplete semicircles corresponding to the interface resistances at Si|SE and In—Li|SE. Therefore, the depressed semicircle in the half cell was attributed to the combined interface resistances at cathode and anode, represented as R_{Int}. Because the grain boundaries widely exist in the cold-pressed sulfide pellet, the depressed semicircles at high frequency were assigned to the grain boundary resistance, R_{GB}. The interception represented the total resistance, R_{SE, bulk}. Constant phase elements (CPE) were utilized to fit the impedance data. The tail at low frequency was attributed to the Warburg region, indicating the ion diffusion in Si.

The EIS spectra were thus fitted with the model of R(RQ)(RQ)Q, as shown in the inset of FIG. 5B. Significantly, the R_{Int} decreased from 101Ω to 33Ω in the initial two hours and gradually increased to 66Ω after a full lithiation. The enhanced electron conductivity can explain the initial reduction in resistance in Si as partial lithiation. The increased resistance at lower potential stemmed from two reasons. The first is that the resistance at the In—Li|SE increased when a large portion of Li ions were extracted from the In—Li alloy.^{[23]} The second was the slight decomposition of sulfide SE, which was further analyzed in the following section. In addition, the R_{GB} and R_{SE, bulk} showed no huge difference during cycling.

The cell was then charged, and the EIS was measured at the same conditions (FIG. 18). FIG. 5C shows the stacked Nyquist plots during cycling, and the points at the frequencies of 10 Hz and 0.04 Hz are also highlighted. The Nyquist plots show a similar shape to that in the discharge process. Overall, the total resistance gradually increased as the cell charged. The same equivalent circuit was employed, as shown in FIG. 5D. The R_{Int} gradually increased from 28Ω to 42Ω when the potential was lower than 0.68 V, and then quickly increased to 148Ω when the Si was fully delithiated, which can be attributed to the enlarged impedance that occurred when fully extracting Li from Si. Overall, the resistance did not significantly change after one cycle, demonstrating the compatibility between Si and sulfide SE.

The compatibility between Li metal and sulfide SE was investigated in a Li|SE|Li symmetric cell. FIG. 5E displays the impedance evolution in the symmetric cell at different rest times before cycling. The resistance gradually increased as the rest time increased, demonstrating the chemical reactions between Li and SE.^{[24]} Then, the cell was cycled at the same current density of 0.25 mA cm⁻² as the Si half-cell, with a one-hour plating and stripping time for each cycle. As shown in FIG. 5F, an overpotential of ˜0.02 V was observed initially and gradually decreased to 0.006 V after four cycles. Notably, a voltage vibration during cycling demonstrated the unstable interface. The corresponding Nyquist plots after each cycle were compared in FIG. 5G. After the first two cycles, there were depressed semicircles observed, demonstrating the normal working of the symmetric cells. However, the impedance dramatically dropped with a negligible capacitive reactance after the third and fourth cycles, highlighted at the inset. This phenomenon agrees with the “soft short” in the solid electrolyte, especially in symmetric cells. FIG. 19 displays the following cycle performance of the symmetric cell. Though the voltage did not drop to zero, no plate and strip shapes were observed, demonstrating the soft short circuit of the symmetric cell. The critical current density of Li metal against SE was further investigated, as shown in FIG. 20. The value was only 0.5 mA cm⁻² which was much lower than that of Si anode.

XPS was employed to reveal the stability of the Si composite anode. FIG. 5H compares the XPS spectra of the Si 2p region before and after one cycle. Initially, besides the prominent peak belonging to Si, a peak corresponding to Si—O was observed, suggesting an oxidized layer on the surface of Si nanoparticles. After one cycle, the peak intensity of Si decreased significantly, accompanied by a newborn peak belonging to SiO₂. Considering there is no O element source in the electrode, this transformation may have been caused by the sample transfer process in XPS measurement. FIG. 5I displays the XPS spectrum of S 2p, pristine and after one cycle. In pristine, the peaks were attributed to the PS₄³⁻ unit of argyrodite-type Li₆PS₅Cl, suggesting good chemical stability between Si and SE. After one cycle, a pair of newborn peaks belonging to Li₂S appeared, demonstrating that the SE experienced a slight decomposition. According to the area ratio of the peaks, only 2.83% of Li₆PS₅Cl degraded after one cycle. The C1 2p region shows representative peaks of Cl⁻ ions and no noticeable difference before and after one cycle (FIG. 5J). Previous work has proved that Li metal shows poor chemical and electrochemical stabilities with sulfide SE.^{[2]} Therefore, the Si anode showed much better compatibility with sulfide SE than Li metal, supporting the EIS results and the electrochemical performance.

The cathode plays an equally important role in determining the energy densities of ASLBs. NMC 811 has attracted excellent attention in industry and academia because of its high discharge capacity of 200 mAh g⁻¹, relatively high average operation voltage of 3.6 V (vs. Li⁺/Li), and lower cost than the conventional LiCoO₂.^{[25]} However, NMC 811 generally exhibits an unsatisfying performance in ASLBs, with low capacity and poor cycling stability. The first cause for this is the unstable interface between sulfide SEs and NMC 811 rooted in chemical and electrochemical reactions.^{[26]} Numerous works have proved that interface engineering introducing an ion conductive, electron insulation coating on NMC can effectively address this issue.^{[27]} Another reason is that the nickel-rich NMC used in most ASLBs are polycrystalline which suffers from chemomechanical failure during cycling.^{[28]} It has been frequently reported that inner cracks form in the secondary particles of polycrystalline NMC 811.^{[29]} Unlike the flowable liquid electrolyte that can access the inner NMC 811 to maintain a good capacity, SEs can only contact the surface of NMC. As a result, the cracks can dramatically hinder the ion diffusion inside the NMC and result in poor reaction kinetic and, therefore, capacity decay.^{[30]}

To address the above challenges, a Li₂SiOₓ coated single-crystal NMC 811 (indicated herein as Li₂SiOₓ@S-NMC) was developed through a facile wet chemical coating method, as illustrated in FIG. 6A. On the one hand, Li₂SiOₓ is an auspicious coating material for industry applications. Li₂SiOₓ can effectively alleviate the degradation of SEs and decrease the interfacial resistance.^{[31]} Li₂SiOₓ is cheaper than the most popular interface coating material, lithium niobate (LiNbO₃). Also, the wet chemical method is scalable and low cost. On the other hand, S-NMC is reported with fast Li⁺ diffusion and eliminated resistance caused by internal grain boundaries and inter-granular fracture compared to polycrystalline NMC.^{[32]} At the same time, S-NMC has a greater robustness than polycrystalline NMC during mixing and densification, enabling remarkable processibility.^{[33]} Therefore, the Li₂SiOₓ@S-NMC is a promising high-performance cathode for industry application of sulfide SE-based ASLBs. Mild ball milling was performed to make the composite cathode, a uniform mixture of S-NMC, SE, and conductive additive with a ratio of 80:20:3 in weight. Vapor grown carbon fiber (VGCF) was added to enhance the electron conduction in the composite cathode and maintain the lowest side effect on the degradation of SE. FIG. 6B illustrates the architecture of the ASLBs, which uses In—Li as a counter electrode to check the electrochemical performance of Li₂SiOₓ@S-NMC.

SEM and energy dispersive X-ray spectroscopy (EDX) mapping were employed to track the Li₂SiOₓ coating. FIG. 6C shows that the bare S-NMC was a single particle in diameter of ˜3 μm, which was a significant contrast to the secondary particles of polycrystalline NMC (FIGS. 21A-B). After being coated with 2 wt. % of Li₂SiOₓ, no noticeable changes were found on the S-NMC, as shown in FIG. 6D. EDX mapping investigation, presented in FIGS. 6E-F, reveals the uniform distribution of Si and Ni elements demonstrating that the Li₂SiOₓ was homogeneously coated on NMC. FIG. 6G displays the EDX spectrum, where the existence of peaks belonging to Si further certified the coating of Li₂SiOₓ. FIG. 6H gives the XRD patterns of S-NMC and Li₂SiOₓ@S-NMC. All the patterns were attributed to the S-NMC, and no new phases were observed in Li₂SiOₓ@S-NMC. It demonstrated that the Li₂SiOₓ coating layer was in an amorphous state and the wet-chemical coating process had no side effect on S-NMC.

FIG. 6I displays the galvanostatic charge and discharge profiles of the half-cell ASLBs of the composite cathode at the first two cycles at the current rate of C/20. Here, 1 C means 200 mA g⁻¹ based on the weight of Li₂SiOₓ@S-NMC. The cell was measured between 2.6 and 4.4 V (vs. Li⁺/Li). High charge and discharge capacities of 224 and 188 mAh g⁻¹ were achieved with a high ICE of 83.9%. After one cycle, no obvious overpotential was observed, and highly reversible charge and discharge capacities of 188 and 186 mAh g⁻¹ were obtained at the second cycle. In comparison, the bare S-NMC delivered lower charge and discharge capacities of 212 and 160 mAh g⁻¹, a lower ICE of 75.5%, and increased overpotential (FIG. 22). The outstanding capacity, high ICE, and excellent capacity reversibility were significantly attributed to the interface engineering of Li₂SiOₓ on S-NMC and the excellent compatibility between Li₂SiOₓ@S-NMC with sulfide SE. FIG. 6J depicts the differential capacities with cell potential at the first two cycles. Three pairs of anodic and cathodic peaks were observed at around 3.75 and 3.69, 4.05 and 3.94, 4.22 and 4.12 V, respectively. The peaks in the low-voltage region were related to the phase transition between monoclinic M and hexagonal H₁ structures. The peaks at the high-voltage region were attributed to the phase transitions among three hexagonal structures, H₁, H₂, and H₃.^{[34]} At the second cycle, no apparent peak shifts were observed, and the peaks during discharge were almost the same as that of the first cycle, which demonstrated stable cycling. In the end, the rate performances of the Li₂SiOₓ@S-NMC were evaluated, as depicted in FIG. 6K. Remarkably, the ASLB delivered average capacities of 187, 160, 144, 90, and 58 mAh g⁻¹ at C/20, C/10, C/5, C/2, and 1 C, respectively. When recharged at C/20 after 1 C, the capacity recovered to 185 mAh g⁻¹, suggesting a highly reversible cycling behavior. Similarly, the counter electrode (In—Li) may have affected the performance of ASLB at a high rate.

To demonstrate the promising application of Si anode in ASLBs, the full cell was fabricated utilizing a Li₂SiOₓ@S-NMC cathode and Si composite anode. FIG. 7A illustrates the architecture of the full cell. Here, one piece of thin SE membrane with a low thickness of 50 μm was employed as the SE middle layer in the ASLB to achieve a cell-level high energy density. The thin SE membrane has a high ionic conductivity of 1.65 mS cm⁻¹ and ultralow areal resistance of 4.32 Ωcm⁻¹, reported in previous work.^{[35]} Two kinds of ASLBs were prepared where the mass loadings of the cathode were 10 mg cm⁻² and 20 mg cm⁻², respectively. The n/p ratio was ˜1.35, calculated based on the cathode and anode capacities in half cells. FIGS. 7B-E presents the SEM image and EDX mapping of the cross section of the full cell with cathode mass loading of 10 mg cm⁻². The thickness of the cathode, SE, and anode layer were 62, 50, and 32 μm, respectively. FIGS. 23A-C show the morphology of composite cathode made of Li₂SiOₓ@S-NMC, SE, and VGCF. A uniform mixing was obtained, and the well-percolated VGCF showed high electron conduction to the Li₂SiOₓ@S-NMC (FIG. 23A). Unlike the relatively loose stack in the cathode, the SE layer was highly dense with no pores, which provided sufficient ion conduction and mechanical strength (FIG. 23B). In the Si composite anode, the Si, SE, and CB were uniformly mixed (FIG. 23C).

FIG. 7F presents the galvanostatic charge and discharge profiles of the full cell at the first two cycles at the rate of C/20 (based on the weight of Li₂SiOₓ@S-NMC). The mass loading of the cathode was 10 mg cm⁻², and the voltage range was between 2.4 to 4.2 V (vs. Li⁺/LiₓSi). The cell delivered outstanding charge and discharge capacities of 229 and 187 mAh g⁻¹ at the first cycle with a high ICE of 81.7%. Unlike the apparent plateau at 3.61 V in the half cell of Li₂SiOₓ@S-NMC, the charge profile in the full cell showed a slope with an onset potential of around 2.51 V, which may be attributed to the lithiation of the partially amorphized Si and the slight decomposition of SE. During discharge, the ASLB showed a typical profile for Si-based full cell with an average potential of 3.39 V. In the following cycle, the charge profile varied slightly due to the amorphization of Si during the first cycle, while the discharge profile was almost the same as that in the first cycle, demonstrating good stability in the cell. The coulombic efficiency reached ˜99.9%. FIG. 7G shows the differential capacities with cell potentials at the first two cycles. Similarly, there were three pairs of charge and discharge peaks at 3.61 and 3.25, 3.93 and 3.63, 4.14 and 3.92 V during the first cycle attributed to the phase changes of S-NMC. In the second cycle, only the first charge peak shifted to a lower potential of 3.51 V according to the change in charge profiles. Notably, a tiny peak at around 2.57 V was observed at the first cycle but disappeared at the second cycle. It suggested that the SE experienced a slight reduction during the first cycle but maintained stability in the following cycles. Compared with the half-cell of Li₂SiOₓ@S-NMC, the ICE decreased from 83.9% to 81.7%, suggesting this side reaction only caused a slight effect.

FIG. 7H displays the rate performance of the full cells with cathode mass loading of 10 and 20 mg cm⁻² labeled as cell I and cell II, respectively. When tested at C/20, C/10, C/5, C/2, and 1 C, cell I delivered average capacities of 184, 178, 163, 144, and 130 mAh g⁻¹, respectively. The capacities at high rates were much higher than the half-cell of Li₂SiOₓ@S-NMC using In—Li as anode material, demonstrating that Si anode was better than In—Li at a high current rate. FIG. 24 shows the corresponding charge/discharge profiles at different rates, where no huge overpotential was observed even at 1 C. When the mass loading of cathode reached 20 mg cm⁻², cell II maintained high average capacities of 167, 156, 140, 112, and 106 mAh g⁻¹ at C/20, C/10C/5 , C/2, and 1 C, respectively. Although the mass loading was doubled, the full cell shows negligible overpotential increase at high rates, as shown in FIG. 25. FIG. 7I displays the long-term cycling performance of cell I and cell II at the rate of C/3. Impressively, cell I showed a remarkable initial capacity of 145 mAh g⁻¹ and maintained stability for 1000 cycles with capacity retention of 62.9%. Cell II showed a lower capacity of 126 mAh g⁻¹ in initial and maintained stability for 650 cycles with a capacity retention of 71.5%. The regular capacity vibration was caused by the temperature change day and night. Cell I delivered stable coulombic efficiencies of˜99% over 1000 cycles, and Cell II showed lower coulombic efficiencies due to the high mass loading. FIG. 26 displays the Raman spectra of the Si anode before and after 1000 cycles. The intensity of Si significantly decreased, indicating the formation of LiₓSi, which was inactive in Raman.^{[36]} No newborn peaks were observed, demonstrating the considerable stability of the sulfide SE in Si composite electrodes in ASLBs.

The cell-level energy densities of the full cells (only including a cathode, SE, and anode) were evaluated to demonstrate the advances of Si anode. FIG. 8 compares the gravimetric energy densities of the full cells using cathode mass loadings of 10 mg cm⁻² (hollow star) and 20 mg cm⁻² (solid star) with other reported full cells using Si-related material as an anode at various current densities. The details of the energy density calculation are listed in FIG. 36. Remarkably, the full cell with 20 mg cm⁻² cathode mass loading delivered the highest energy density of 285 Wh kg⁻¹. Even at the high current density of 3.16 mA cm⁻², the energy density was as high as 177 Wh kg⁻¹. Meanwhile, few ASLBs using Li metal anode reached this current density. These outstanding performances were evidence that Si anode showed great potential in practical application in ASLBs compared to Li metal at the current stage.

For the next step large-scale commercialization, the scaling up of Si anode based ASLBs needed further investigations in electrode composition optimization, including adding conductive carbon additive and binder. It has been reported that the carbon additives accelerated the decomposition of SE, and the carbon-free microsilicon (μ-Si) anode enabled highly stable ASLBs.^{[15]} Herein, the performance of the pure Si nanoparticles was evaluated in the full cell. FIG. 27 displays the charge and discharge profiles of the ASLBs with pure Si at different rates. The cathode mass loading was 10 mg cm⁻², and the N/P ratio was ˜1.3. The cell delivered an initial discharge capacity of 127 mAh g⁻¹ with an initial coulombic efficiency of 63.2%, much lower than 184 mAh g⁻¹ and 81.7% of the Si composite anode with carbon. Moreover, the full cell with pure Si anode delivered a low capacity of 81 mAh g⁻¹ at 1C, while the full cell with Si composite anode had a higher value of 130 mAh g⁻¹. It demonstrated that the mixing with carbon and SE benefited a better utilization of Si in this work, especially at a high rate, which was different from the reported result.^{[15]} One possible reason is that the Si nanoparticles have an enlarged surface area compared to the μ-Si, accompanied by more boundaries in pure Si electrodes. There was generally a layer of silicon oxide on the surface of Si nanoparticles which causes a three orders reduction in electrical conductivity.^{[37]} As a result, the utilization of Si was limited without carbon, and the ASLBs delivered poor behavior. It demonstrates that adding carbon with proper ratio benefits the Si nanoparticle based ASLBs. Further, in a large-scale application, the addition of binders brings more challenges to the conductivity of Si anode. Therefore, carbon additives are critical in building sufficient electron conductive pathways, especially in commercialized cells.

In addition, considering the intimate physical contact between Si, SE, and CB is challenging in the ASLBs, the effect of interface coating on Si, like the carbon coating (C@Si) and SE coating (SE@C), was also investigated in this work. The carbon coating was conducted through the dopamine polymerization and following carbonization processes. The SE coating was fabricated based on a wet synthesis of Li₇P₃S₁₁ (LPS), and the ionic conductivity was around 0.6 mS cm⁻¹. FIGS. 28A-B show SEM images of C@Si and LPS@Si, which all maintained the morphology of Si nanoparticles. The fraction of the carbon coating was ˜10 wt. % which was confirmed by thermogravimetry analysis (FIG. 29). The fraction of the LPS was ˜10 wt. % controlled by the precursor ratio. Then, C@Si and LPS@Si were mixed with Li₆PS₅Cl and CB as the same formula with Si-SE-CB to prepare C@Si-SE and LPS@Si-SE-CB. FIGS. 30A-B show the half-cell performance of C@Si-SE. An extra electrochemical reaction occurred at 1.091 V, which was attributed to the partial reduction of SE. The enlarged contact between C and SE may have accelerated the decomposition of SE.^{[15]} Meanwhile, the carbon coating blocked the ion accessibility to Si. As a result, the cell delivered a low ICE of 57.6%. The LPS@Si-SE-CB showed better performance than C@Si-SE but lower capacity (2689 mAh g⁻¹) and ICE (77.6%) than Si-SE-CB, as shown in FIGS. 31A-B. The lower ionic conductivity of LPS than Li₆PS₅Cl can explain it, and the LPS coating may block the electron conduction in the composite anode. The full cell performances of C@Si-SE and LPS@Si-SE-CB anodes were also investigated. As displayed in FIGS. 32A-B, the full cell using C@Si-SE anode showed deficient capacity (78 mAh g⁻¹), poor ICE (44.8%), and sluggish reaction kinetics. FIGS. 33A-B show the performance of full cells using LPS@Si-SE-CB. A higher capacity of 162 mAh g⁻¹ and ICE of 81% was obtained. These results agreed with the half-cell performance, demonstrating that a sole carbon or ionic conductor coverage between Si and sulfide electrolyte might block the counterpart charge transfer: pure carbon coating might block ion transfer; pure ionic conductor coating might block electron transfer.

Another significant issue was the addition of binders. Advanced binders enable electrode fabrication through film casting, which benefits scaling up and better compatibility with the existing manufacturing line of current LiBs.^{[38]} Meanwhile, the binder improves the electrode mechanical stability and benefits the ASLBs working at lower external pressure.^{[39]} However, the binder blocks the electron and ion transfer and impedes battery performance due to the ionic and electronic insulating. In order to minimize the side effect, the binder needs to meet the superior binding ability to reduce usage amount. Meanwhile, the binder should have excellent electrochemical and chemical stability with both active material and SE. The processing method must also be compatible with sulfide SE which is highly sensitive to moisture and polar solvents.

To demonstrate the scalability of Si anode based ASLBs, a pouch cell with a size of 3×3 cm⁻² was assembled, as shown in FIGS. 34A-D. The freestanding cathode and SE layer were prepared through dry mixing method using 1 wt. % of polytetrafluoroethylene (PTFE) as the binder.^{[39]} The anode was prepared through a slurry casting method using 2 wt. % of ethyl cellulose as the binder. The pouch cell was fabricated through stacking Al foil, cathode, SE, and anode/Cu in sequence. The as prepared pouch cell lit a bulb successfully. Due to lacking external pressure, the cell has a large impedance, demonstrating that pressure is critical for Si anode based ASLBs.

### Conclusion

In summary, the Si composite anode was successfully prepared through a facile ball milling method in this work. The half-cell delivered a high capacity of 2773 mAh g⁻¹ (corresponding to 2.64 mAh cm⁻²) with an ICE of 85.6% at 0.1 mA cm⁻². Also, the cell showed a high capacity of 2067 mAh g⁻¹ and maintained stability for 200 cycles at 0.5 mA cm⁻². Operando EIS measurement revealed that the Si composite anode exhibited good stability during cycling though the SE had a slight decomposition to Li₂S, which possessed descent ionic conductivity for stable cycling. In contrast, Li metal anode suffered severe chemical and electrochemical instabilities with sulfide SE. A series of interface engineering on Si, including carbon coating, ionic conductor coating, and the hybrid coating, caused sluggish counterpart charge transfer in the Si composite anode and accelerated the decomposition of SE. On the cathode side, a low-cost Li₂SiOₓ layer was fabricated on single-crystal NMC 811 to stabilize the interface with sulfide SE. As a result, the full cell employing Si composite anode, thin SE membrane, and the Li₂SiOₓ@S-NMC cathode delivered a remarkable performance with a cell level energy density of 285 Wh kg⁻¹ at a high cathode mass loading of 20 mg cm⁻². At a high current density of 3.16 mA cm⁻², the energy density at cell level still reached 177 Wh kg⁻¹. This work sheds light on the commercialization of ASLBs and advances Si anode in the practical application of ASLBs.

Briefly, Si anode showed superior compatibility with sulfide SE-based ASLBs compared with Li metal anode. Si anode was highlighted with low cost, excellent stability with sulfide SE, remarkable processibility in ASLBs, high critical current density, and promising scale-up. All these merits enable Si anode as one of the most promising anodes utilized in ASLBs. Although Li metal has the highest energy density, several challenges such as the poor stability, low critical current density, dendrite growth issue, and strict processing conditions still limit the application of Li metal in ASLBs for large-scale industrial manufacturing.

### Experimental

### Materials Synthesis and Preparation

### Li₆PS₅Cl preparation

The argyrodite Li₆PS₅Cl was synthesized through a solid-state sintering method. Lithium sulfide (Li₂S, Sigma-Aldrich, 99.98%), phosphorus pentasulfide (P₂S₅, Sigma-Aldrich, 99%), and lithium chloride (LiCl, Sigma-Aldrich, 99%) were mixed in a molar ratio of 2.5:0.5:1 using a 50 mL of stainless-steel vacuum for 10 hours at 500 rpm under an argon atmosphere. The mixture was sealed in a glass tube and then sintered at 550° C. for 6 hours. The obtained sample was then ground in a mortar and stored in a glovebox.

### LPS@SI Preparation

The Si powder (Nanostructured & Amorphous Materials, Inc.) was used directly as received without further treatment. The Li₇P₃S₁₁ (LPS) coated silicon powder (LPS@Si) was synthesized through the wet chemical method. 270 mg of Si powders were mixed with 10.7 mg of Li₂S and 19.3 mg of P₂S₅ in 10 mL of acetonitrile with continuous stirring for 24 hours at 50° C. The acetonitrile was then removed under a vacuum. The L₇P₃S₁₁@Si was obtained after annealing at 260° C. for 1 hour in an Argon-filled glovebox.

### C@Si Preparation

The C@Si was synthesized through Dopamine polymerization and following carbonization processes. 300 mg of Si powder were mixed with 300 mg of dopamine hydrochloride (Alfa Aesar, >99.0%) in Tris buffer (300 mL, 10 mM; pH 8.5) and stirred for 12 hours. Then polydopamine@Si was obtained through centrifugation and washing with water three times. The freeze-dried polydopamine@Si was then carbonized in an N₂ filled tube furnace at 400° C. for 2 hours with a heating rate of 1° C. min⁻¹ and then at 800° C. for 4 hours with a heating rate of 5° C. min⁻¹. The C@Si powders were obtained.

### Li₂SiOₓ Coating on Single-crystal NMC 811

The coating of Li₂SiOₓ on single-crystal NMC 811 was conducted through wet-chemical methods. Tetraethyl orthosilicate (TEOS, Sigma-Aldrich, ≥99.0%), lithium (Li, Sigma-Aldrich, 99.9%), anhydrous ethanol (Sigma-Aldrich), and single-crystal NMC 811 (Nanoramic Inc.) were utilized. Briefly, 3.1 mg of Li was reacted with 1.2 mL of ethanol to form the ethanol solution of lithium ethoxide, and 50 μL of TEOS was then added with stirring for 10 minutes at 300 rpm. After that, 1 g of NMC powder was mixed in the above solutions, and a continuous stirring at 300 rpm was kept for 1 hour. All the experiments were performed in the glovebox. Then a vacuum was applied to remove the extra ethanol. A bath sonication was maintained to avoid the aggregation of NMC. The dried mixture was heated at 350° C. for 2 hours in a muffle furnace with ambient air. The obtained sample was stored in a glovebox for further use.

### Materials Characterization

X-ray diffraction (XRD) was measured on PANalytical/Philips X'Pert Pro (PANalytical, Netherlands) with Cu Ka radiation. The samples were sealed with Kapton tape for protection. The Raman spectra were obtained on a Thermo Scientific DXR (Thermo Scientific, USA) with 532 nm laser excitation. The scanning electron microscopy (SEM) and energy dispersive X-ray spectroscopy (EDX) were conducted on SEM JEOL JSM 7000F (JEOL Ltd., JAPAN). The samples were cut with a REXBETI single edge razor blade to check the cross-section morphology. Thermogravimetric analysis (TGA) was performed on TGA Q50 (TA Instruments Inc., USA) from room temperature to 800° C. at a heating rate of 10° C. min⁻¹ in air. The X-ray photoelectron spectroscopy (XPS) was conducted on a K-Alpha XPS system (Thermo Scientific, USA).

### Electrochemical Evaluation

### Si Composite Anodes Preparation

All Si composite anodes were prepared through a facile ball milling method. For Si-SE-CB, 180 mg of Si powder, 90 mg of Li₆PS₅Cl, and 30 mg of carbon black (acetylene, 99.9+%, Fisher Scientific) were mixed in an Argon-filled milling jar (50 mL) at 500 rpm for 5 hours. 2 g of ZrO₂ balls (4 mm in diameter) were used. The Si-SE-CB was obtained. For C@Si-SE, C@Si and SE were mixed in a ratio of 70:30 by the same method. For LPS@Si-SE-CB, LPS@Si, Li₆PSCl, and CB were mixed in the ratio of 70:20:10 by the same method.

### Cathode Preparation

The cathode was prepared through a ball milling method. 160 mg of Li₂SiOₓ@S-NMC powder, 40 mg of Li₆PS₅Cl, and 6 mg of Vapor grown carbon fiber (VGCF) were mixed in an Argon filled milling jar (50 mL) at 150 rpm for 1 hour. 1.2 g of ZrO₂ (4 mm in diameter) was used. The cathode was collected and stored in a glovebox.

### Thin SE Layer Fabrication

The fabrication of the thin SE layer was reported in previous work.^{[35]} In detail, 2 mg of ethyl cellulose was dissolved in 2 mL of toluene at 50° C. After stirring for 2 hours, 98 mg of Li₆PS₅Cl powder was dispersed in the above solution with a continuous stirring at 300 rpm for 2 hours. The dispersion was then casted on a vacuum filtration system with a filter diameter of 4.4 cm. A freestanding membrane was successfully obtained after peeling off from the filter paper. The membrane was heated at 150° C. overnight to remove the residual solvent. The thin SE layer was stored in the glovebox for future use.

### Half-Cell Fabrication

The half-cell fabrication was conducted in the glovebox (O₂<0.1 ppm, H₂O<0.1 ppm). First, 150 mg of Li₆PS₅Cl powder was pressed in a PEEK die (12.7 mm in diameter) under a pressure of 300 MPa. Then 2 mg of composite anodes were cast on one side of the Li₆PS₅Cl pellet; a piece of In—Li foil (40 mg of In, 1 mg of Li) was stacked on the other side. The copper foil was used as the current collector for both sides. Pressure at 100 MPa was then applied on the die with two stainless steel plugs. Finally, an extra pressure of 50 MPa was applied to the cell and maintained by a stainless-steel framework. The Li₂SiOₓ@S-NMC half-cell was fabricated with a similar method while 10 or 20 mg cm⁻² of the composite cathode are applied, and In—Li worked as anodes.

### Full Cell Fabrication

The full cell fabrication was fabricated based on a thin SE membrane. 10 mg of Si composite anode was first dispersed in 1 mL of toluene, then 200 uL of dispersion was dropped on the Cu disk (12.7 mm). After heating at 200° C. for 2 hours, the Si composite anode was uniformly cast on the Cu disk. The preparation of the thin SE membrane was reported in previous work.^{[35]} A piece of thin SE membrane with a diameter of 12.7 mm was placed in the PEEK die (12.7 mm in diameter) and then pressed at 100 MPa. Then the anode disk was stacked on one side; cathode (10 or 20 mg cm⁻²) powder were cast on the other side. Al foil was selected as the current collector. The stacked cell was finally pressed at 300 MPa, and an extra pressure of 50 MPa was applied to the cell and maintained by a stainless-steel framework.

### Operando EIS Analysis

The operando EIS was conducted on a Biologic SP150 potentiostat (Biologic, France). For the Si anode, the half-cell was assembled for measurement. The cell was galvanostatically charged and discharged at a current density of 0.25 mA cm⁻². The EIS was measured every hour after a rest for 30 min. The measurement was carried out at frequencies from 1 MHz to 10 mHz with an AC amplitude of 10 m V. For the Li metal anode, a symmetric cell was assembled. 150 mg of Li₆PS₅Cl was pressed in the PEEK die at a pressure of 300 MPa. Then, two pieces of Li metal foil were stacked on both sides. Cu foil was used as current collectors. The EIS measurement before cycling was conducted every two hours. Then the cell was galvanostatic charged and discharged at the current density of 0.25 mA cm⁻² and limited capacity of 0.25 mAh cm⁻² for each cycle. The EIS was measured after a rest of 30 min. The setting for EIS was the same as that of the Si anode. ZSimpWin was used for EIS fitting.

### Rate and Cycling Performance Measurement

The Si anode half-cell was first discharged to −0.6 V and then charged to 0.9 V in constant current density. The specific capacity was calculated based on the weight of Si. The potential of the In—Li foil used here was 0.6 V. The Li₂SiOₓ@S-NMC cathode half-cell was first charged to 3.8 V at constant current, held at 3.8 V for one hour, and then discharged to 2.0 V at the same current. The full cell was first charged to 4.2 V at constant current, held at 4.2 V for one hour, and then discharged to 2.4 V at the same current rate. The specific capacity was calculated based on Li₂SiOₓ@S-NMC.

### REFERENCES

[1] X. Yu, A. Manthiram, Energy Storage Materials 2021, 34, 282.
[2] Q. Zhang, D. Cao, Y. Ma, A. Natan, P. Aurora, H. Zhu, Adv. Mater. 2019, 31, 1901131; X. Sun, A. M. Stavola, D. Cao, A. M. Bruck, Y. Wang, Y. Zhang, P. Luan, J. W. Gallaway, H. Zhu, Advanced Energy Materials 2021, 11, 2002861.
[3] Y. Zhu, X. He, Y. Mo, ACS applied materials & interfaces 2015, 7, 23685.
[4] D. Cao, Y. Zhao, X. Sun, A. Natan, Y. Wang, P. Xiang, W. Wang, H. Zhu, ACS Energy Letters 2020, 5, 3468.
[5] in Mineral Commodity Summaries, Reston, VA 2021, 200.
[6] J. Lu, Z. Chen, F. Pan, Y. Cui, K. Amine, Electrochemical Energy Reviews 2018, 1, 35.
[7] B. Zhu, X. Wang, P. Yao, J. Li, J. Zhu, Chemical Science 2019, 10, 7132.
[8] X.-B. Cheng, R. Zhang, C.-Z. Zhao, Q. Zhang, Chemical Reviews 2017, 117, 10403.
[9] T. Krauskopf, F. H. Richter, W. G. Zeier, J. Janek, Chemical Reviews 2020, 120, 7745; O. Sheng, J. Zheng, Z. Ju, C. Jin, Y. Wang, M. Chen, J. Nai, T. Liu, W. Zhang, Y. Liu, X. Tao, Advanced Materials 2020, 32, 2000223.
[10] D. Cao, X. Sun, Q. Li, A. Natan, P. Xiang, H. Zhu, Matter 2020, 3, 57.
[11] M. Ashuri, Q. He, L. L. Shaw, Nanoscale 2016, 8, 74.
[12] X. Su, Q. Wu, J. Li, X. Xiao, A. Lott, W. Lu, B. W. Sheldon, J. Wu, Advanced Energy Materials 2014, 4, 1300882.
[13] J. Trevey, J. S. Jang, Y. S. Jung, C. R. Stoldt, S.-H. Lee, Electrochemistry Communications 2009, 11, 1830; N. A. Dunlap, S. Kim, J. J. Jeong, K. H. Oh, S.-H. Lee, Solid State Ionics 2018, 324, 207; D. M. Piper, T. A. Yersak, S.-H. Lee, Journal of The Electrochemical Society 2012, 160, A77.
[14] R. Miyazaki, N. Ohta, T. Ohnishi, I. Sakaguchi, K. Takada, Journal of Power Sources 2014, 272, 541; R. B. Cervera, N. Suzuki, T. Ohnishi, M. Osada, K. Mitsuishi, T. Kambara, K. Takada, Energy & Environmental Science 2014, 7, 662.
[15] D. H. S. Tan, Y.-T. Chen, H. Yang, W. Bao, B. Sreenarayanan, J.-M. Doux, W. Li, B. Lu, S.-Y. Ham, B. Sayahpour, J. Scharf, E. A. Wu, G. Deysher, H. E. Han, H. J. Hah, H. Jeong, J. B. Lee, Z. Chen, Y. S. Meng, Science 2021, 373, 1494.
[16] Y. Wang, T. Liu, J. Kumar, ACS Applied Materials & Interfaces 2020, 12, 34771.
[17] J.-M. Doux, H. Nguyen, D. H. S. Tan, A. Banerjee, X. Wang, E. A. Wu, C. Jo, H. Yang, Y. S. Meng, Advanced Energy Materials 2020, 10, 1903253.
[18] M. A. Hopcroft, W. D. Nix, T. W. Kenny, Journal of microelectromechanical systems 2010, 19, 229.
[19] M. Yamamoto, Y. Terauchi, A. Sakuda, M. Takahashi, Journal of Power Sources 2018, 402, 506.
[20] W. Wang, P. N. Kumta, ACS Nano 2010, 4, 2233; C. K. Chan, H. Peng, G. Liu, K. McIlwrath, X. F. Zhang, R. A. Huggins, Y. Cui, Nature Nanotechnology 2008, 3, 31.
[21] M. K. Datta, P. N. Kumta, Journal of Power Sources 2009, 194, 1043.
[22] F. Sun, K. Dong, M. Osenberg, A. Hilger, S. Risse, Y. Lu, P. H. Kamm, M. Klaus, H. Markötter, F. García-Moreno, T. Arlt, I. Manke, Journal of Materials Chemistry A 2018, 6, 22489.
[23] W. Zhang, D. A. Weber, H. Weigand, T. Arlt, I. Manke, D. Schröder, R. Koerver, T. Leichtweiss, P. Hartmann, W. G. Zeier, J. Janek, ACS Applied Materials & Interfaces 2017, 9, 17835.
[24] Y. Liu, Y. Wu, J. Zheng, Y. Wang, Z. Ju, G. Lu, O. Sheng, J. Nai, T. Liu, W. Zhang, X. Tao, Nano Energy 2021, 82, 105723; Z. Ju, C. Jin, H. Yuan, T. Yang, O. Sheng, T. Liu, Y. Liu, Y. Wang, F. Ma, W. Zhang, J. Nai, X. Tao, Chemical Engineering Journal 2021, 408, 128016.
[25] Y. Zhang, X. Sun, D. Cao, G. Gao, Z. Yang, H. Zhu, Y. Wang, Energy Storage Materials 2021, 41, 505.
[26] C. Wang, J. Liang, Y. Zhao, M. Zheng, X. Li, X. Sun, Energy & Environmental Science 2021, 14, 2577.
[27] D. Cao, Y. Zhang, A. M. Nolan, X. Sun, C. Liu, J. Sheng, Y. Mo, Y. Wang, H. Zhu, Nano Lett. 2020, 20, 1483; J. Janek, W. G. Zeier, Nature Energy 2016, 1, 16141; S. P. Culver, R. Koerver, W. G. Zeier, J. Janek, Advanced Energy Materials 2019, 9, 1900626.
[28] S. Schweidler, L. de Biasi, G. Garcia, A. Mazilkin, P. Hartmann, T. Brezesinski, J. Janek, ACS Applied Energy Materials 2019, 2, 7375.
[29] H.-H. Ryu, K.-J. Park, C. S. Yoon, Y.-K. Sun, Chemistry of Materials 2018, 30, 1155.
[30] R. Ruess, S. Schweidler, H. Hemmelmann, G. Conforto, A. Bielefeld, D. A. Weber, J. Sann, M. T. Elm, J. Janek, Journal of The Electrochemical Society 2020, 167, 100532.
[31] A. Sakuda, A. Hayashi, M. Tatsumisago, Chem. Mater. 2010, 22, 949.
[32] X. Liu, B. Zheng, J. Zhao, W. Zhao, Z. Liang, Y. Su, C. Xie, K. Zhou, Y. Xiang, J. Zhu, H. Wang, G. Zhong, Z. Gong, J. Huang, Y. Yang, Advanced Energy Materials 2021, 11, 2003583; C. Wang, R. Yu, S. Hwang, J. Liang, X. Li, C. Zhao, Y. Sun, J. Wang, N. Holmes, R. Li, H. Huang, S. Zhao, L. Zhang, S. Lu, D. Su, X. Sun, Energy Storage Materials 2020, 30, 98.
[33] C. Doerrer, I. Capone, S. Narayanan, J. Liu, C. R. M. Grovenor, M. Pasta, P. S. Grant, ACS Applied Materials & Interfaces 2021.
[34] X. Dong, J. Yao, W. Zhu, X. Huang, X. Kuai, J. Tang, X. Li, S. Dai, L. Shen, R. Yang, L. Gao, J. Zhao, Journal of Materials Chemistry A 2019, 7, 20262.
[35] D. Cao, Q. Li, X. Sun, Y. Wang, X. Zhao, E. Cakmak, W. Liang, A. Anderson, S. Ozcan, H. Zhu, Advanced Materials 2021, 33, 2105505.
[36] Z. Zeng, N. Liu, Q. Zeng, S. W. Lee, W. L. Mao, Y. Cui, Nano Energy 2016, 22, 105.
[37] A. Gupta, S. Hartner, H. Wiggers, “Optical and electrical properties of silicon nanoparticles”, presented at 2010 3rd International Nanoelectronics Conference (INEC), 3-8 Jan. 2010, 2010.
[38] L. Han, T. Liu, O. Sheng, Y. Liu, Y. Wang, J. Nai, L. Zhang, X. Tao, ACS Applied Materials & Interfaces 2021, 13, 45139.
[39] F. Hippauf, B. Schumm, S. Doerfler, H. Althues, S. Fujiki, T. Shiratsuchi, T. Tsujimura, Y. Aihara, S. Kaskel, Energy Storage Materials 2019, 21, 390.
[40] N. A. Dunlap, J. Kim, H. Guthery, C.-S. Jiang, I. Morrissey, C. R. Stoldt, K. H. Oh, M. Al-Jassim, S.-H. Lee, Journal of The Electrochemical Society 2020, 167, 060522.
[41] M. Yamamoto, Y. Terauchi, A. Sakuda, M. Takahashi, Journal of Power Sources 2018, 402, 506.
[42] D. H. Kim, H. A. Lee, Y. B. Song, J. W. Park, S.-M. Lee, Y. S. Jung, Journal of Power Sources 2019, 426, 143.
[43] M. Yamamoto, Y. Terauchi, A. Sakuda, A. Kato, M. Takahashi, Journal of Power Sources 2020, 473, 228595.
[44] S. Cangaz, F. Hippauf, F. S. Reuter, S. Doerfler, T. Abendroth, H. Althues, S. Kaskel, Advanced Energy Materials 2020, 10, 2001320.

### INCORPORATION BY REFERENCE; EQUIVALENTS

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. A method of making an anode material, the method comprising:
a) milling silicon particles, Li₆PS₅Cl and carbon black to form an anode material.

2. The method of claim 1, wherein the silicon particles, the Li₆PS₅Cl, and the carbon black are milled in a weight ratio of about 60:30:10.

3. The method of claim 1, wherein the silicon particles are coated with Li₆P₃S₁₁.

4. The method of claim 1, further comprising coating the silicon particles with Li₇P₃S₁₁, wherein coating the silicon with Li₇P₃S₁₁ comprises
a) mixing the silicon particles with Li₂S and P₂S₅ in a solvent;
b) removing the solvent; and
c) annealing the silicon particles to form to form silicon particles coated with Li₂P₃S₁₁.

5. The method of claim 4, wherein the silicon particles coated with Li₂P₃S₁₁, the Li₆PS₅Cl, and the carbon black are milled in a weight ratio of about 70:20:10.

6. The method of claim 1, wherein the silicon particles are powdered silicon particles.

7. The method of claim 6, wherein the powdered silicon particles are silicon nanoparticles.

8. The method of claim 7, wherein the silicon nanoparticles have a particle size from about 50 nm to about 100 nm.

9. A cathode comprising a metal that comprises nickel, manganese, and cobalt, wherein the metal is coated with Li₂SiOₓ, and wherein X is from 2.9 to 3.0.

10. A method of making a cathode material, the method comprising:
coating a metal that comprises nickel, manganese, and cobalt, wherein coating the metal comprises:
i) reacting lithium with ethanol to form lithium ethoxide dissolved in the ethanol;
ii) adding tetraethyl orthosilicate to the lithium ethoxide dissolved in the ethanol;
iii) adding the metal that comprises nickel, manganese, and cobalt to the ethanol; and
iv) removing the ethanol, thereby forming a coated metal that comprises nickel, manganese, and cobalt;
b) milling the coated metal that comprises nickel, manganese, and cobalt with Li₆PS₅Cl and carbon fibers to form a cathode material.

11. The method of claim 10, further comprising sonicating the ethanol to reduce aggregation of the metal that comprises nickel, manganese, and cobalt.

12. The method of claim 10, wherein coating the metal is performed in an inert atmosphere.

13. The method of claim 10, wherein the carbon fibers are vapor-grown carbon fibers.

14. The method of claim 10, wherein the metal that comprises nickel, manganese, and cobalt is LiNi_{0.8}Mn_{0.1}Co_{0.1}O₂.

15. The method of claim 10, wherein the metal that comprise nickel, manganese, and cobalt is a single crystal.

16. A battery comprising:
a) an anode comprising silicon particles, Li₆PS₅Cl, and carbon black;
b) the cathode of claim 9; and
c) a solid electrolyte membrane separating the anode and the cathode.

17. The battery of claim 16, wherein the metal that comprises nickel, manganese, and cobalt is LiNi_{0.8}Mn_{0.1}Co_{0.1}O₂.

18. The battery of claim 16, wherein the metal that comprise nickel, manganese, and cobalt is a single crystal.

19. The battery of claim 16, wherein the silicon particles are coated with Li₆PS₅Cl.

20. (canceled)

21. (canceled)

22. (canceled)

23. (canceled)

24. (canceled)

25. (canceled)

26. (canceled)

27. (canceled)

28. The method of claim 1, wherein the silicon particles are coated with carbon by:
a) mixing the silicon particles with dopamine hydrochloride to make polydopamine-coated silicon particles; and
b) heating the polydopamine-coated silicon particles in an inert atmosphere to form carbon-coated silicon particles;
c) milling carbon-coated silicon particles and Li₆PS₅Cl to form an anode material.

29. (canceled)

30. (canceled)

31. (canceled)
